(19) United States
(12) Patent Application Publication
(10) Pub. No.: US 2014/0241168 A1
(43) Pub. Date: Aug. 28, 2014

(54) INDICATING WHETHER DATA WAS SUBJECTED TO INTERFERENCE

(71) Applicant: QUALCOMM Incorporated, San Diego, CA (US)

(72) Inventors: Simone MERLIN, Solana Beach, CA (US); Rahul TANDRA, San Diego, CA (US); Gwendolyn Denise BARRIAC, Encinitas, CA (US); Yan ZHOU, San Diego, CA (US); Hemanth SAMPATH, San Diego, CA (US); Vincent Knowles JONES IV, Redwood City, CA (US)

(73) Assignee: QUALCOMM Incorporated, San Diego, CA (US)

(21) Appl. No.: 14/184,651

(22) Filed: Feb. 19, 2014

Related U.S. Application Data
(60) Provisional application No. 61/768,975, filed on Feb. 25, 2013.

(51) Int. Cl. H04L 12/26

(52) U.S. Cl. CPC H04L 43/0829
USPC 370/241

(57) ABSTRACT

An explicit indication is provided regarding whether information was subjected to interference during transmission. For example, a receiver can monitor received packets and determine whether any of data units in a given received packet were subjected to interference during transmission. If so, the receiver can send an indication to the transmitter to inform the transmitter of the interference. This indication enables the transmitter to distinguish between packet loss that occurred as a result of channel fade and packet loss that occurred as a result of interference. Consequently, the transmitter is able to invoke different actions depending on whether the packet loss is due to channel fade or interference.

### CLAIM OF PRIORITY

This application claims the benefit of and priority to commonly owned U.S. Provisional Patent Application No. 61/768,975, filed Feb. 25, 2013, and assigned Attorney Docket No. 131695P1, the disclosure of which is hereby incorporated by reference herein.

### BACKGROUND

1. Field

This application relates generally to wireless communication and more specifically, but not exclusively, to indicating interference.

2. Introduction

Communication networks enable users to exchange messages among several interacting spatially-separated devices. Communication networks may be classified according to geographic scope, which could be, for example, a wide area, a metropolitan area, a local area, or a personal area. Such networks may be designated respectively as a wide area network (WAN), a metropolitan area network (MAN), a local area network (LAN), or a personal area network (PAN). Communication networks also differ according to the switching technique and/or routing technique employed to interconnect the various network apparatuses and devices. For example, a communication network may use circuit switching, packet switching, or some combination of the two. Communication networks can differ according to the type of physical media employed for transmission. For example, a communication network may support wired communication, wireless communication, or both types of communication. Communication networks can also use different sets of communication protocols. Examples of such communication protocols include the Internet protocol (IP) suite, synchronous optical networking (SONET) protocols, and Ethernet protocols.

In general, wireless networks employ intangible physical media in an unguided propagation mode using electromagnetic waves in radio, microwave, infrared, optical, or other frequency bands. Consequently, wireless networks are better adapted to facilitate user mobility and rapid field deployment as compared to fixed, wired networks. For example, wireless networks readily support network elements that are mobile and have dynamic connectivity needs. The use of wireless networks also may be preferred for scenarios where it is desirable to provide a network architecture having an ad hoc topology, rather than a fixed topology.

Some types of wireless networks use rate adaptation to maintain a high level of communication performance. For example, rate adaptation may be employed in a wireless network such as a wireless LAN (WLAN) whereby a transmitter is able to adapt the transmission rate that it uses to send packets to a receiver. In a typical scenario, a decision as to whether and how to adapt a rate is based on whether packets previously transmitted by the transmitter were successfully received at the receiver.

Some types of rate adaptation are based on statistics regarding an open loop packet error rate (PER). One example of this type of rate adaptation is adaptive automatic rate fallback (AARF). Through the use of AARF or other similar algorithms, a transmitter can measure packet losses and adapt its transmission rate accordingly. For example, the transmitter may reduce its transmission rate if it observes an increase in packet losses.

Some types of rate adaptation are based on feedback from a receiver that indicates how much data has been lost. For example, in a Wi-Fi network (i.e., an IEEE 802.11-based network), a receiver can provide feedback that indicates the number of media access control (MAC) protocol data units (MPDUs) that were lost (i.e., transmitted by the transmitter, but not received by the receiver). The receiver can send this information to the transmitter via, for example, a Block Acknowledgment (ACK) bitmap.

In some implementations, rate adaptation is based on feedback that indicates a signal-to-noise ratio (SNR) and/or link budget. For example, a transmitter may reduce its transmission rate upon receipt of feedback from a receiver that indicates that an SNR/link budget has decreased.

Some types of rate adaptation are based on closed loop feedback. Here, a receiver may determine a preferred rate (e.g., a preferred modulation and coding scheme (MCS)) for receiving data and send an explicit indication of this preferred rate to the transmitter. The transmitter then determines whether it is able to meet this preferred rate. If so, the transmitter uses the preferred rate to transmit data to the receiver.

### SUMMARY

A summary of several example aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to techniques for improving communication performance in a wireless system. In practice, conventional rate adaptation schemes might not provide desired performance in certain scenarios. For packet loss due to channel fading, conventional rate adaptation may effectively account for channel fading by adjusting the rate in the face of a high path loss between a transmitter and a receiver. However, for packet loss due to collisions (i.e., interference), conventional rate adaptation might not effectively account for interference. In this case, a reduction in rate triggered by interference-induced packet loss will cause transmissions to take longer. Consequently, interference in the wireless network may actually increase under these circumstances.

The disclosure relates in some aspects to providing an explicit indication as to whether information was subjected to interference during transmission of the information. For example, a receiver can monitor received packets and determine whether any of the data units (e.g., MPDUs) in a given received packet were subjected to interference during transmission. If so, the receiver sends an indication to the transmitter to inform the transmitter of the interference. This indication enables the transmitter to distinguish between packet loss that occurred as a result of channel fade and packet loss that occurred as a result of interference. Consequently, the transmitter is able to invoke different actions depending on whether the packet loss is due to channel fade or interference. For channel fade, the transmitter may adjust its transmission rate. For interference, on the other hand, the transmitter might not adjust its transmission rate. Instead, the transmitter may take action to reduce the interference. For example, the transmitter can reduce interference by modifying medium access parameters, modifying a medium access schedule, protecting transmissions with a contention scheme (e.g., request-to-send/clear-to-send (RTS/CTS)), or by taking other appropriate action.

Various aspects of the disclosure provide an apparatus configured for wireless communication. The apparatus comprising: a receiver configured to receive at least one data unit transmitted by a second apparatus; a processing system configured to generate at least one indication that indicates whether the at least one data unit was subjected to interference during the transmission of the at least one data unit; and a transmitter configured to transmit the at least one indication to the second apparatus.

Further aspects of the disclosure provide a method of wireless communication. The method comprising: receiving, at a first apparatus, at least one data unit transmitted by a second apparatus; generating at least one indication that indicates whether the at least one data unit was subjected to interference during the transmission of the at least one data unit; and transmitting the at least one indication from the first apparatus to the second apparatus.

Still further aspects of the disclosure provide another apparatus configured for wireless communication. The apparatus comprising: means for receiving at least one data unit transmitted by a second apparatus; means for generating at least one indication that indicates whether the at least one data unit was subjected to interference during the transmission of the at least one data unit; and means for transmitting the at least one indication to the second apparatus.

Additional aspects of the disclosure provide a computer-program product comprising a computer-readable medium. The computer-readable medium comprising code executable to: receive, at a first apparatus, at least one data unit transmitted by a second apparatus; generate at least one indication that indicates whether the at least one data unit was subjected to interference during the transmission of the at least one data unit; and transmit the at least one indication from the first apparatus to the second apparatus.

Other aspects of the disclosure provide a wireless device. The wireless device comprising: an antenna; a receiver configured to receive, via the antenna, at least one data unit transmitted by an apparatus; a processing system configured to generate at least one indication that indicates whether the at least one data unit was subjected to interference during the transmission of the at least one data unit; and a transmitter configured to transmit the at least one indication to the apparatus.

Also, various aspects of the disclosure provide another apparatus configured for wireless communication. The apparatus comprising: a transmitter configured to transmit at least one data unit to a second apparatus; a receiver configured to receive at least one indication transmitted by the second apparatus, wherein the at least one indication indicates whether the at least one data unit was subjected to interference during the transmission of the at least one data unit; and a processing system configured to determine, based on the at least one indication, at least one transmission parameter for transmission of at least one other data unit from the apparatus to the second apparatus.

Further aspects of the disclosure provide another method of wireless communication. The method comprising: transmitting at least one data unit from a first apparatus to a second apparatus; receiving, at the first apparatus, at least one indication transmitted by the second apparatus, wherein the at least one indication indicates whether the at least one data unit was subjected to interference during the transmission of the at least one data unit; and determining, based on the at least one indication, at least one transmission parameter for transmission of at least one other data unit from the first apparatus to the second apparatus.

Still further aspects of the disclosure provide another apparatus configured for wireless communication. The apparatus comprising: means for transmitting at least one data unit to the second apparatus; means for receiving at least one indication transmitted by the second apparatus, wherein the at least one indication indicates whether the at least one data unit was subjected to interference during the transmission of the at least one data unit; and means for determining, based on the at least one indication, at least one transmission parameter for transmission of at least one other data unit from the apparatus to the second apparatus.

Additional aspects of the disclosure provide another computer-program product comprising a computer-readable medium. The computer-readable medium comprising code executable to: transmit at least one data unit from a first apparatus to a second apparatus; receive, at the first apparatus, at least one indication transmitted by the second apparatus, wherein the at least one indication indicates whether the at least one data unit was subjected to interference during the transmission of the at least one data unit; and determine, based on the at least one indication, at least one transmission parameter for transmission of at least one other data unit from the first apparatus to the second apparatus.

Other aspects of the disclosure provide another wireless device. The wireless device comprising: an antenna; a transmitter configured to transmit, via the antenna, at least one data unit to an apparatus; a receiver configured to receive at least one indication transmitted by the apparatus, wherein the at least one indication indicates whether the at least one data unit was subjected to interference during the transmission of the at least one data unit; and a processing system configured to determine, based on the at least one indication, at least one transmission parameter for transmission of at least one other data unit from the wireless device to the apparatus.

### BRIEF DESCRIPTION OF THE DRAWINGS

These and other sample aspects of the disclosure will be described in the detailed description and the claims that follow, and in the accompanying drawings, wherein:

FIG. 1 illustrates an example of a network environment in which one or more aspects of the disclosure may find application;

FIG. 2 illustrates another example of a network environment in which one or more aspects of the disclosure may find application;

FIG. 3 is a block diagram illustrating communication between two apparatuses in accordance with some aspects of the disclosure;

FIG. 4 is a flowchart illustrating several sample operations relating to transmitting an indication of interference in accordance with some aspects of the disclosure;

FIG. 5 is a flowchart illustrating several sample operations relating to receiving an indication of interference in accordance with some aspects of the disclosure;

FIG. 6 is a flowchart illustrating several additional sample operations relating to transmitting an indication of interference in accordance with some aspects of the disclosure;

FIG. 7 is a flowchart illustrating several additional sample operations relating to receiving an indication of interference in accordance with some aspects of the disclosure;

FIG. 8 is a diagram illustrating an A-MPDU Parameters Field in accordance with some aspects of the disclosure;

FIG. 9 is a diagram illustrating a VHT Capabilities Info Field in accordance with some aspects of the disclosure;

FIG. 10 is a diagram illustrating a Supported MCS Set Field in accordance with some aspects of the disclosure;

FIG. 11 is a diagram illustrating an HT Extended Capabilities Field in accordance with some aspects of the disclosure;

FIG. 12 is a diagram illustrating an HT Operation Information Field in accordance with some aspects of the disclosure;

FIG. 13 is a diagram illustrating a Per TID Info Subfield in accordance with some aspects of the disclosure;

FIG. 14 is a diagram illustrating a Block ACK (BA) Starting Sequence Control Field in accordance with some aspects of the disclosure;

FIG. 15 is a diagram illustrating a BA Control Field in accordance with some aspects of the disclosure;

FIG. 16 is a diagram illustrating a Frame Control Field in accordance with some aspects of the disclosure;

FIG. 17 is a diagram illustrating an HT Control Middle Subfield of an HT variant HT Control Field in accordance with some aspects of the disclosure;

FIG. 18 is a diagram illustrating an HT Control Middle Subfield of an VHT variant HT Control Field in accordance with some aspects of the disclosure;

FIG. 19 is a block diagram illustrating an example of an apparatus that may be employed within a wireless communication system in accordance with some aspects of the disclosure;

FIG. 20 is a block diagram illustrating an example of components that may be utilized in the apparatus of FIG. 19 to transmit wireless communication;

FIG. 21 is a block diagram illustrating an example of components that may be utilized in the apparatus of FIG. 19 to receive wireless communication;

FIG. 22 is a block diagram illustrating examples of components that may be employed in communication nodes in accordance with some aspects of the disclosure; and

FIGS. 23 and 24 are simplified block diagrams illustrating examples' of apparatuses configured with functionality relating to use of an indication of interference in accordance with some aspects of the disclosure.

In accordance with common practice, the features illustrated in the drawings are simplified for clarity and are generally not drawn to scale. That is, the dimensions and spacing of these features are expanded or reduced for clarity in most cases. In addition, for purposes of illustration, the drawings generally do not depict all of the components that are typically employed in a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, any aspect disclosed herein may be embodied by one or more elements of a claim. As an example of the above, in some aspects, a method of communication comprises: receiving, at a first apparatus, at least one data unit transmitted by a second apparatus; generating at least one indication that indicates whether the at least one data unit was subjected to interference during the transmission of the at least one data unit; and transmitting the at least one indication from the first apparatus to the second apparatus. In addition, in some aspects, the at least one indication identifies each of the data units that was subjected to interference.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols.

In some aspects, wireless signals may be transmitted according to an 802.11 protocol using orthogonal frequency-division multiplexing (OFDM), direct-sequence spread spectrum (DSSS) communication, a combination of OFDM and DSSS communication, or other schemes.

Certain of the devices described herein may further implement Multiple Input Multiple Output (MIMO) technology and be implemented as part of an 802.11 protocol. A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels or streams, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices that are the components that access the wireless network. For example, there may be two types of devices: access points (“APs”) and clients (also referred to as stations, or “STAs”). In general, an AP serves as a hub or base station for the WLAN and an STA serves as a user of the WLAN. For example, a STA may be a laptop computer, a personal digital assistant (PDA), a mobile phone, etc. In an example, an STA connects to an AP via a WiFi (e.g., IEEE 802.11 protocol) compliant wireless link to obtain general connectivity to the Internet or to other wide area networks. In some implementations, an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

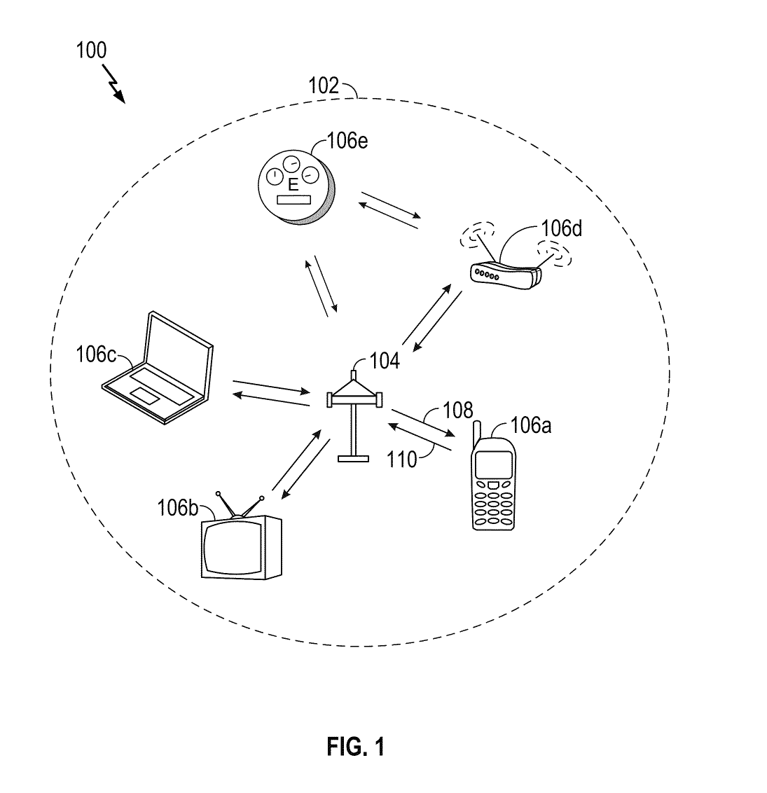

FIG. 1 illustrates an example of a wireless communication system 100 in which aspects of the disclosure may be employed. The wireless communication system 100 may operate pursuant to a wireless standard, for example the 802.11 standard. The wireless communication system 100 may include an AP 104, which communicates with STAs 106a, 106b, 106c, 106d, and 106e (collectively STAs 106).

STA 106e may have difficulty communicating with the AP 104 or may be out of range and unable to communicate with the AP 104. As such, another STA 106d may be configured as a relay device (e.g., a device comprising STA and AP functionality) that relays communication between the STA 106e and the AP 104.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106. Also, as mentioned above, a relay may incorporate at least some of the functionality of an AP and a STA.

Access point 104a may communicate with station 106b during either a contention period or a contention free period within the wireless communication system 100. During a contention period for wireless communication system 100, transmissions between station 106b and access point 104a may collide with transmissions from other wireless stations within communication system 100. Depending on the utilization of wireless communication system 100, the collision rate may vary. When the wireless communication system 100 is under relatively heavy utilization, the percent of transmissions that experience one or more collisions may be relatively higher than when the wireless communication system 100 is less heavily utilized. Collisions experienced during heavy utilization of wireless communication system 100 may prevent reception of data by wireless nodes of wireless communication system 100. Some packets experiencing collisions may not be acknowledged by the intended receiver. Alternatively, block acknowledgements (BAs) may be transmitted from a receiver to a transmitter, indicating a reception status for each of a plurality of packets.

The transmission of some wireless messages may fail due to reasons other than collisions. For example, the physical distance between a STA 106 and an AP 104 may be large relative to the transmission power of either the STA 106 or AP 104. When a transmitted signal is received at a receiver, it may be too weak to be properly decoded. This type of transmission error is known in the art as fading. Packets experiencing fading may not be acknowledged by the intended receiver. Alternatively, block acknowledgments may be transmitted by a receiver to an original transmitter, indicating a reception station for each of a plurality of packets.

In response to unsuccessful transmission of one or more packets, a transmitter may adjust transmission parameters in an attempt to improve communication with the receiver. For example, the transmitter may lower the Modulation and Coding Scheme (MCS) and lengthen the packet duration. If the transmission problems are due to fading, this may improve an ability of a receiver that is receiving a weak transmission signal to decode a wireless message transmitted with the lower MCS. If the transmission problems are due to collisions, lengthening the transmission time of a wireless message may exacerbate transmission issues on a heavily utilized network, since longer packets are more susceptible to being interrupted by a collision.

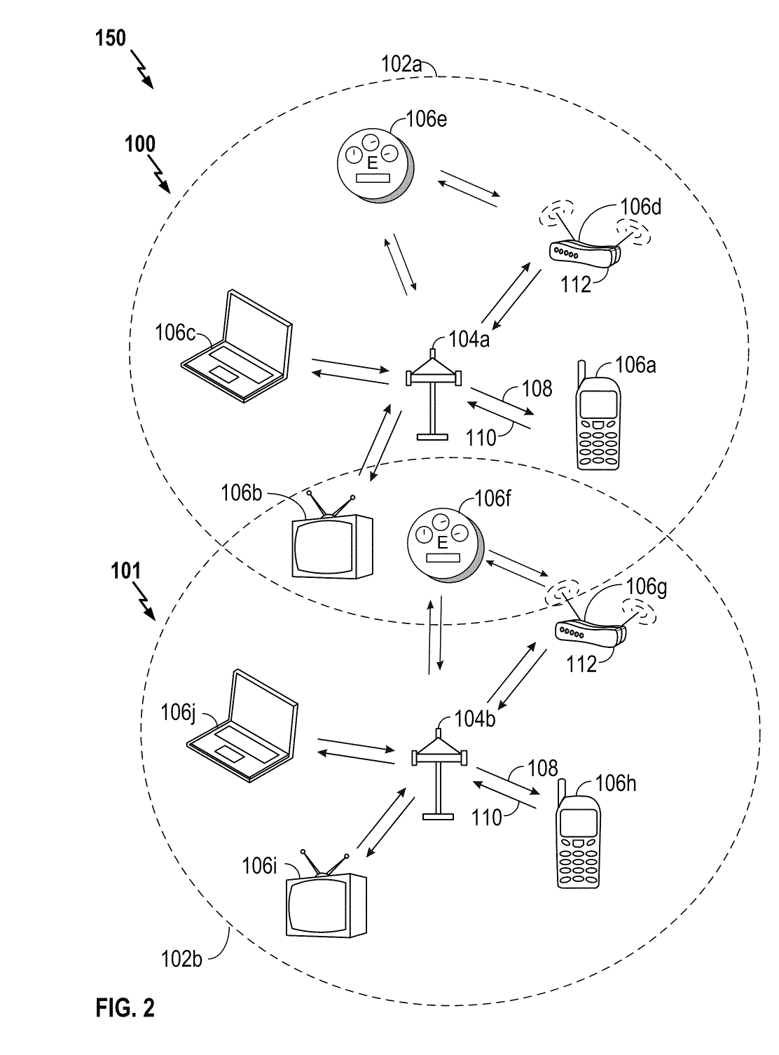

FIG. 2 illustrates an example of a wireless communication system 150 in which aspects of the disclosure may be employed. The wireless communication system 150 may operate pursuant to a wireless standard, for example the 802.11 standard. Wireless communication system 150 includes the wireless communication system 100 illustrated in FIG. 1, as well as a second wireless communication system 101. The wireless communication system 150 includes APs 104a-b, which communicate with STAs 106a-e within wireless communication system 100 and STAs 106f-j respectively within wireless communication system 101 (collectively STAs 106).

Station 106b is associated with and communicates with AP 104a, but is also within the transmission range of access point 104b. Station 106f is associated with and communicates with AP 104b, but is also within the transmission range of access point 104a.

As discussed above, stations may communicate with an access point either during a contention period or during a contention free period. During a contention free period of wireless communication system 100, collisions will generally not occur with other transmissions from devices of communication system 100. However, since station 106b is within the transmission range of AP 104b, it may experience packet collisions during a contention free period due to transmissions from wireless communication system 150. Depending on the utilization of the communication system 101, the frequency of transmissions by AP 104b may vary. If wireless communication system 101 is heavily utilized, station 106b may experience collisions resulting from transmissions of AP 104b, even during a contention free period of wireless communication system 100.

In response to packet losses, AP 104a may adjust its transmission parameters. In some cases, however, such an adjustment may increase the likelihood of additional collisions. For example, if a packet transmitted during a contention free period between AP 104a and STA 106b collides with a transmission from AP 104b, the AP 104a may assume the transmission failed due to fading. Consequently, the AP 104a may lower the MCS and lengthen the transmission time of the packet. However, this may increase the likelihood that a retransmission of the packet also collides with a transmission from AP 104b, especially if the wireless communication system 101 is heavily utilized. Therefore, improved techniques for responding to packet collisions in a wireless communication system are desired.

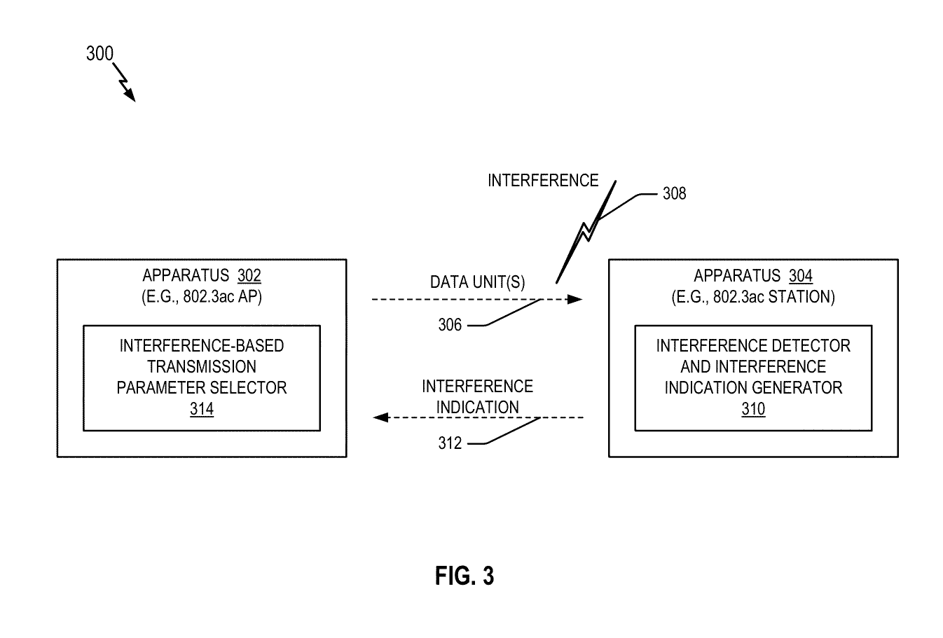

Referring to FIG. 3, the disclosure relates in some aspects to improving communication on a wireless network experiencing transmission errors due to collisions or other forms of interference that occur when a first apparatus 302 transmits a message 306 (e.g., comprising at least one data unit) to a second apparatus 304. In the discussion that follows, the first apparatus 302 may be referred to as the transmitter since it transmits the data unit(s) of interest, while the second apparatus 304 may be referred to as the receiver since it receives the data unit(s) of interest.

Upon receipt of the message 306, the second apparatus 304 (the receiver) may determine the nature of any issues with the received message 306. For example, the second apparatus 304 may determine whether the message 306 was subjected to interference (e.g., burst interference) as represented by a symbol 308. The second apparatus 304 also may determine whether there were any packet errors as a result of the interference. To this end, the apparatus 304 includes an interference detector and interference indication generator 310 that detects interference associated with an incoming signal and, in the event interference is detected, generates an indication of this interference.

The second apparatus 304 may then transmit a message 312 to the first apparatus 302 (the transmitter) indicating whether the message 306 was subjected to interference. In some implementations, the message 312 also indicates whether the message 306 included errors caused by interference.

Upon receiving this interference indication, the first apparatus 302 selects one or more transmission parameters for a subsequent transmission. To this end, the first apparatus 302 includes an interference-based transmission parameter selector 314 that selects (e.g., adapts) the transmission rate (e.g., MCS) and/or other transmission parameters depending on whether the message 306 was subjected to interference. For example, when packet errors are due to interference, the first apparatus 302 (transmitter) might not lower the MCS and might not increase the length of packet transmissions, since these actions may exacerbate transmission problems in a heavily utilized wireless network or wireless medium. Thus, by feeding back to the first apparatus 302 an indication as to whether transmitted data was subjected to interference, the first apparatus 302 is able to improve its adaptation of transmission parameters as compared to a conventional adaptation scheme where transmission parameters are adapted based only on whether a packet was or was not correctly received.

Various types of indications (e.g., metrics) may be transmitted by a receiver to indicate whether a data unit was subjected to interference. In some aspects, such an indication may indicate whether a data unit was lost due to channel fade or interference.

In some implementations, an interference indication indicates that a packet was subjected to interference. For example, the indication may comprise one bit indicating if the received packet experienced interference at some point during transmission. Thus, the bit may be set if any one of the data units in the packet was subjected to interference. In this case, the indication does not indicate how many data units or which data units were subjected to interference.

In some implementations, an interference indication indicates that a specific data unit was subjected to interference. For example, the indication may comprise one bit per data unit, where each bit indicates whether the corresponding data unit experienced interference. In conjunction with this indication, another indication may be provided that indicates whether the data unit was lost or not (e.g., as indicated by a Block ACK bitmap). In some aspects, a “lost” data unit may correspond to a data unit that was transmitted by a transmitter but was not “successfully” received by a receiver.

In some implementations, an interference indication indicates that a specific data unit was lost due to interference. For example, the indication may comprise one bit per data unit, where each bit indicates whether the corresponding lost data unit experienced interference. This form of indication may not work in all scenarios. For example, in some cases, a receiver might not be able to determine how many MPDUs were in the received packet if one or more of the MPDUs were lost.

In some implementations, an interference indication provides an indication relative to the physical layer. For example, the indication may comprise N bits indicating that the packet started experiencing interference at symbol X and/or time Y. As another example, the indication may comprise N bits indicating the packet experienced interference on X symbols and/or for time duration Y.

In some implementations, an interference indication provides an indication of the strength of the interference. For instance, the interference indication may represent the signal-to-noise-and-interference ratio (SINR) experienced during a time interval within which interference was detected. As another example, the interference indication may represent the difference between the SINR during the time interval with detected interference and the SINR during a time interval without detected interference. The indication may represent the intensity (strength) of the interference in dBs or some other suitable unit of measure. In addition, the intensity of the interference may be quantized (e.g., with a step of 5 dB).

A transmitter may use the indication to decide whether to lower the MCS in the following transmissions. For example, in case the interference is very strong, it may not be beneficial to lower the MCS, since the interference would likely be destructive. Alternatively, in case the interference is of low magnitude, lowering the MCS may result in successful reception of the data, although at a lower transmission rate.

Various types of signaling may be used to send an interference indication (e.g., metric) from a receiver to a transmitter. Signaling of interference indications may be achieved by defining new messages or by modifying existing messages. For example, a new standardized message could be defined that supports such an indication. As another example, changes could be made to a standardized message to support the indication. As yet another example, an indication could be “hidden” in an existing message (e.g., in the case of a proprietary solution).

Interference indications may be transmitted at various times. In some cases, indications are fed back per each packet. In some cases, indications are fed back in an aggregated form. For example, such an indication may indicate how many of the data units or what percentage of the data units were subjected to interference.

In conjunction with the indication signaling (e.g., metric signaling), some type of capability exchange may be employed between a transmitter and a receiver. That is, a transmitter will need to know whether to expect indications from the receiver. Similarly, a receiver will need to know whether a transmitter will act on the indications sent by the receiver.

The information included in the capability exchange may depend in some aspects on the type of signaling used. In a case where new messages are defined for indication signaling, the capability exchange may indicate the ability of a transmitter to receive such a message and the ability of a receiver to transmit such a message. In a case where information is “hidden” in an existing message (e.g., frame), the capability exchange may indicate where the information is and how to parse it.

In some cases, the manner of indication signaling may be adapted based on the capabilities of the transmitter and/or receiver. For example, indications may be sent back with each ACK or Block ACK (BA) if this is supported by the transmitter and receiver. As another example, indications may be sent on-demand in response to a request if this is supported by the transmitter and receiver.

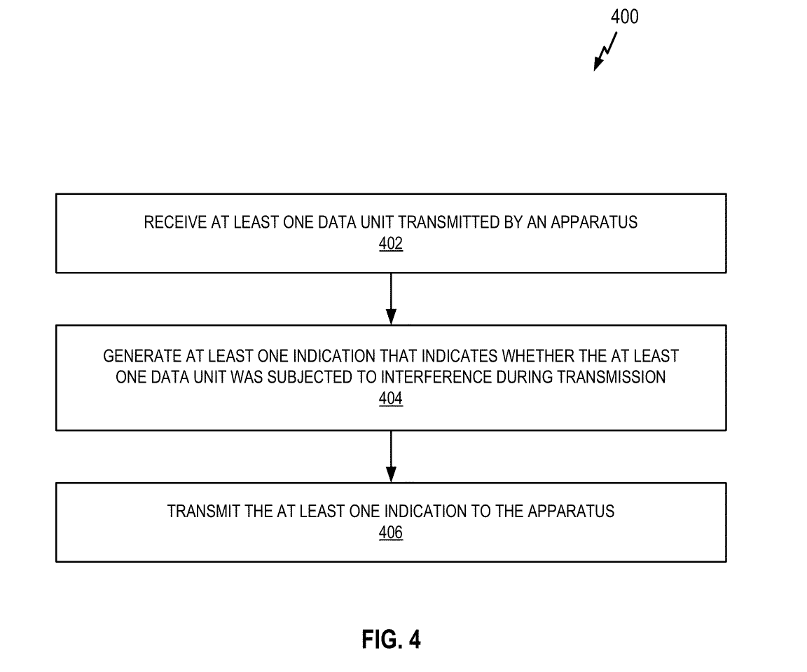

With the above in mind, examples of operations that may be performed in conjunction with indicating interference in accordance with the teachings herein will be described in more detail with reference to the flowcharts of FIGS. 4-7. For purposes of illustration, the described operations may be described as being performed by a specific apparatus. It should be appreciated, however, that these operations may be performed by different types of apparatuses in different implementations. Also, one or more of the operations described herein may not be employed in a given implementation.

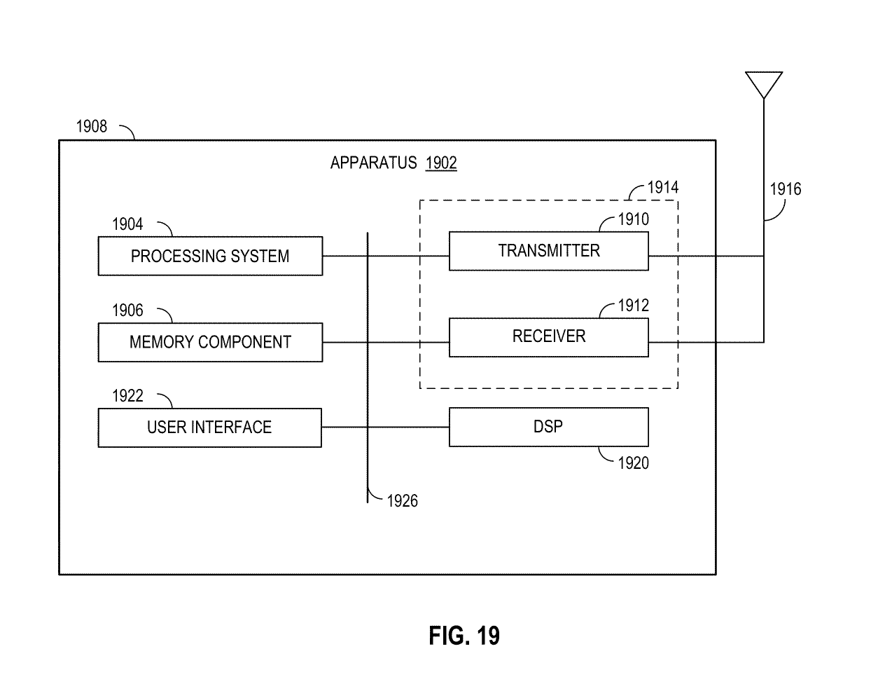

FIG. 4 illustrates a method 400 including operations for generating and transmitting an interference indication in accordance with some aspects of the disclosure. In some aspects, the method 400 may be performed by a first apparatus that receives data units from a second apparatus and, as applicable, transmits an interference indication back to the second apparatus. In some aspects, the method 400 may be performed by the apparatus 302 and/or the apparatus 304 illustrated in FIG. 3. In other aspects, the method 400 may be performed by a processing system (e.g., the processing system 1904 of FIG. 19). Of course, in various aspects within the scope of the disclosure, the method 400 may be implemented by any suitable apparatus capable of supporting interference-related operations.

As represented by block 402, at some point in time, a first apparatus receives at least one data unit transmitted by a second apparatus. For example, the second apparatus may transmit a packet that includes one or more data units. Accordingly, the first apparatus may receive a single data unit (e.g., in a packet) in some cases, while in other cases the first apparatus may receive a plurality of data units (e.g., in one or more packets).

In some implementations, each data unit may comprise a uniquely identifiable set of data. For example, each data unit may be delineated from other information (e.g., from other data units) in a packet. This delineation may be accomplished, for example, by a defining a specific set of bit positions for each data unit, by separating a data unit through the use of a known bit delineation bit pattern, or by some other suitable delineation.

As represented by block 404, the first apparatus determines whether the at least one data unit received at block 402 was subjected to interference during the transmission of the at least one data unit from the second apparatus to the first apparatus. In conjunction with this determination, the first apparatus generates at least one indication that indicates whether the at least one data unit was subjected to interference.

The indication(s) of interference generated here may take various forms. Several examples follow.

In some implementations, a single indication is used to indicate that interference occurred at some point during the transmission of a plurality of data units. For example, a bit may be used to indicate that interference occurred during the transmission of a packet that includes multiple data units.

In some cases where a plurality of data units were received at block 402, the at least one indication of block 404 may identify each of the data units that was subjected to interference. For example, for a packet that has four data units, four bits may be used to indicate, on an individual basis, the data units that were subjected to interference. That is, there is one-to-one correspondence between the data units and the bits, each data unit being associated with a unique one of the bits. Thus, in some scenarios, the operations of block 404 involve generating multiple indications.

In some implementations, the generation of the at least one indication comprises: accumulating information regarding how many of the data units were subjected to interference, and generating a metric based on the accumulated information. For example, such an indication may comprise a count that indicates how many of the data units were subjected to interference. Alternatively, such an indication may comprise a metric that indicates what percentage of the data units were subjected to interference.

In some implementations, if the at least one data unit was subjected to interference during the transmission of the at least one data unit, the generation of the at least one indication may comprise: measuring at least one magnitude of the interference; and generating at least one metric based on the measured at least one magnitude of interference. In some aspects, the at least one metric may comprise at least one of: an SINR measured for the at least one data unit subjected to interference; or an SINR difference between an SINR measured for the at least one data unit subjected to interference and an SINR measured during a period of time when no interference is detected.

In implementations where the interference detection is performed at the physical layer, the indication of block 404 may provide physical layer-related information. For example, the at least one data unit may comprise a plurality of symbols. In this case, the at least one indication may indicate (e.g., identify) at least one of the symbols that was subjected to interference. As another example, the at least one indication may indicate (e.g., identify) a quantity of the symbols that were subjected to interference.

A dynamic bit map may be employed in some implementations. For example, the number of bits in a given indication may correspond to the number of data units subjected to interference (e.g., in the last packet, in the last 10 packets, in the last minute, etc.).

Various techniques may be employed to determine whether a received data block was subjected to interference

In some implementations, interference detection is performed at the physical layer. Here, it should be appreciated that during transmission, the data unit comprises (e.g., the data unit information is carried by) a plurality of symbols. Thus, the first apparatus may determine whether any of these symbols was subjected to interference. This determination may involve identifying the specific symbols that were subjected to interference, the number of symbols that were subjected to interference, the percentage of symbols that were subjected to interference, and so on. Also, information regarding the timing of the interference (e.g., the time when the interference occurred, how long the interference lasted, etc.) may be maintained.

Various algorithms may be employed for processing received signals to determine whether a received data block or set of symbols was subjected to interference. Several examples of such algorithms follow.

In a first example algorithm, interference detection involves tracking phase and/or frequency offsets for a pilot channel, applying corrections to a data channel based on the tracked phase and/or frequency offsets, and detecting bursty interference based on the tracked phase and/or frequency offsets.

Initially, the first apparatus tracks a phase and/or frequency offset for a pilot channel. For example, the first apparatus may estimate a phase offset indicating a change in phase based on pilot tones in ODFM signals received from the second apparatus. The first apparatus can also calculate a frequency offset based on the received signal and/or pilot tones.

Next, the first apparatus applies corrections to a data channel based on the tracked phase and/or frequency offsets. For example, the first apparatus can apply corrections to the data channel calculated to cancel the offsets tracked above. Because signal propagation may be similar for the pilot tones and data, the offsets determined for the known pilot tones can be applied to the data.

Finally, the first apparatus detects bursty interference based on the tracked phase and/or frequency offsets. In some cases, bursty interference can cause the offsets to be much higher than normal. Accordingly, the first apparatus can compare the frequency offset to a threshold that indicates bursty interference. For example, the first apparatus can determine that bursty interference is present when the frequency offset is greater than 1 kHz. In some cases, the first apparatus compares the phase offset to a threshold that indicates bursty interference.

In a second example algorithm, interference detection involves tracking error and strength metrics for a message and detecting bursty interference based on the error and strength metrics.

Initially, the first apparatus tracks error and strength metrics for the data units. For example, the first apparatus can track a receive (RX) error vector magnitude (EVM) for the MPDUs received from the second apparatus. In some cases, the first apparatus can estimate the RX EVM while decoding the MPDUs based on the root-mean-square (RMS) distance between ideal constellation points and decoded constellation points. The first apparatus can further track a received signal strength indication (RSSI) and/or a noise floor.

When there is no bursty interference, the error metric may be proportional to the strength metric. For example, the RX EVM may be directly (or inversely) proportional to the RSSI (which, in some implementations, can be defined relative to a noise floor). In other words, in the absence of bursty interference, a weak RSSI may coincide with a poor RX EVM. On the other hand, in the presence of strong bursty interference, the error metric may indicate high error rates, even while the strength metric indicates high strength. For example, the EX EVM may indicate a high error rate when the RSSI indicates a high signal strength.

Next, the first apparatus can calculate a ratio between the error metric and the strength metric, and compare the result to a threshold. In some cases, the first apparatus can calculate a ratio between the error metric and the strength metric minus a noise floor. The threshold can be predetermined and/or dynamically determined (for example, as discussed above with respect to the offset threshold). When the ratio exceeds the threshold, the first apparatus can determine that bursty interference is present. Likewise, when the ratio does not exceed the threshold, the first apparatus can determine that bursty interference is not present.

In a third example algorithm, interference detection involves decoding a message, remodulating the decoded message, canceling the remodulated message from the original received message, and performing packet detection on a residual signal resulting from the cancelation.

Initially, the first apparatus decodes one or more data units of an original signal received from the second apparatus. For example, the first apparatus can decode the MPDUs into decoded MPDUs. In some cases, bursty interference may be present during reception and decoding of one or more MPDUs. In some cases, the interference might not be strong enough to cause failed MPDUs.

Next, the first apparatus remodulates the decoded data units. For example, the first apparatus can remodulate the decoded MPDUs. Remodulating the decoded MPDUs can recreate or partially simulate the original signal (although the original signal may be slightly different). Accordingly, the remodulated MPDUs can indicate what the original signal should have been, had it been received without interference.

Subsequently, the first apparatus cancels the remodulated data units from the original signal. For example, the first apparatus can store a copy of the original signal received from the second apparatus, and subtract the remodulated signal from the stored original. The first apparatus can cancel the remodulated data units partially or in stages. The first apparatus also may store the canceled signal in memory.

Finally, the first apparatus performs packet detection on the residual signal resulting from the cancelation. Where interference is present during transmission of the data units, the residual signal can be at least partially indicative of the interference. Accordingly, where the interference is bursty interference containing a packet transmitted by another device, the interference may contain an indication that the data is part of a packet, for example, a preamble, a guard interval, etc.

If the first apparatus detects an indication that the residual signal includes a colliding packet (such as a preamble or guard interval), the first apparatus can determine that bursty interference was present during reception. Likewise, if the first apparatus does not detect an indication that the residual signal includes a colliding packet (such as a preamble or guard interval), the first apparatus can determine that bursty interference was not present during reception.

As represented by block 406 of FIG. 4, after the at least one interference indication is generated at block 404, the first apparatus transmits the at least one indication to the second apparatus. For example, the indication may be included in a specified field of a previously defined frame or a new frame may be defined for carrying this indication. FIGS. 15-18, discussed below, illustrate several examples of how such an indication may be carried in an IEEE 802.11 frame.

As mentioned above, in some implementations, the indication takes the form of a bit field. For example, a given bit of the field may indicate whether a corresponding data block was subjected to interference.

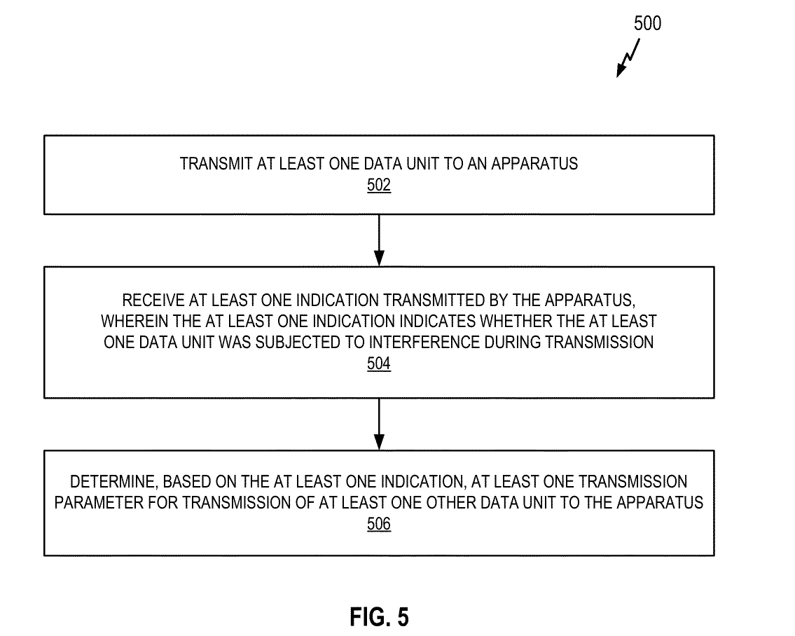

Corresponding operations performed at an apparatus (the second apparatus discussed above) that receives such an indication are described in FIG. 5. Note that the nomenclature for the first apparatus and the second apparatus is reversed in FIG. 5 relative to the nomenclature used in FIG. 4. That is, in FIG. 5, a first apparatus receives an interference indication from a second apparatus.

FIG. 5 illustrates a method 500 including operations for determining a transmission parameter based on a received interference indication in accordance with some aspects of the disclosure. In some aspects, the method 500 may be performed by the apparatus 302 and/or the apparatus 304 illustrated in FIG. 3. In other aspects, the method 500 may be performed by a processing system (e.g., the processing system 1904 of FIG. 19). Of course, in various aspects within the scope of the disclosure, the method 500 may be implemented by any suitable apparatus capable of supporting interference-related operations.

As represented by block 502, the first apparatus transmits at least one data unit to the second apparatus. These operations are complementary to the operations of block 402 discussed above. Thus, the data units transmitted here may be in the form and/or sent in the manner described above.

The data units in a packet may be associated with an error detection code. For example, a transmitter may generate an error detection code that covers an entire packet. As another example, each of data units in a packet may be associated with a corresponding error detection code that is based on the data unit. That is, for each data unit, the transmitter may generate a corresponding error detection code.

As represented by block 504, the first apparatus receives at least one indication transmitted by the second apparatus, where the at least one indication indicates whether the at least one data unit transmitted at block 502 was subjected to interference during transmission. These operations are thus complementary to the operations of block 406 discussed above. Hence, the received indication(s) may be of the form described above in conjunction with FIG. 4.

Thus, in scenarios where the at least one data unit comprises a plurality of data units, the at least one interference indication may indicate that at least one of the data units was subjected to interference. For example, if the data units are contained within a packet, the at least one indication may indicate that one or more of the data units of the packet were subjected to interference.

Alternatively, the at least one interference indication may identify each of the data units that was subjected to interference. For example, the at least one interference indication may comprise a plurality of indications where there is a one-to-one correspondence between the indications and the data units.

Also in scenarios where the at least one data unit comprises a plurality of data units, the at least one indication may comprise accumulated information indicative of how many of the data units were subjected to interference. For example, such a count may correspond to a given packet, a number of packets, a period of time, or some other scenario under which multiple data units are transmitted.

In situations where the at least one data unit was subjected to interference during the transmission of the at least one data unit, the at least one indication may comprise at least one metric indicative of at least one magnitude of the interference. For example, the at least one metric may comprise at least one of: an SINR measured for the at least one data unit subjected to interference; or an SINR difference between an SINR measured for the at least one data unit subjected to interference and an SINR measured during a period of time when no interference is detected.

In scenarios where the at least one data unit comprises a plurality of symbols, the at least one indication may identify at least one of the symbols that was subjected to interference. Alternatively, or in addition, the at least one indication may identify a quantity of the symbols that were subjected to interference.

As represented by block 506, the first apparatus determines at least one transmission parameter for transmission of at least one other data unit from the first apparatus to the second apparatus. In some aspects, this determination is based on the indication(s) received at block 504. In some aspects, this determination comprises determining whether to adapt a modulation and coding scheme.

For example, if little or no interference is indicated and high packet losses are occurring, the first apparatus may select a lower transmission rate (e.g., by adapting the current modulation and coding scheme). In contrast, if significant interference is indicated, the first apparatus may maintain the current transmission rate, while taking steps to mitigate the interference (e.g., switching channels, timeslots, coding, etc.).

As another example, the first apparatus's rate adaptation may ignore the failure of any data units due to interference. Thus, the losses will not appear to the first apparatus to be as high. Consequently, the rate adaptation might not reduce the rate as severely as compared to a conventional rate adaptation algorithm that does not know the cause of the losses.

The determination of a transmission parameter at block 506 may take various forms in different implementations. In implementations where the second apparatus (receiver) selects a transmission parameter (e.g., MCS) and tells the first apparatus (transmitter) to use that transmission parameter for transmissions to the second apparatus, the first apparatus may adjust the specified transmission parameter (e.g., reduce a transmission rate) in the event an interference indication is received.

In implementations where the first apparatus selects a transmission parameter (e.g., MCS) based on, for example, channel information (e.g., SNR) and/or error-related information (e.g., whether a data unit was lost) received from the second apparatus, the first apparatus may adapt the manner in which it selects this transmission parameter based on the interference indication. For example, as discussed above, a transmitter may ignore data block losses that are due to interference, or the transmitter might not reduce the rate by as much as it would absent the interference indication.

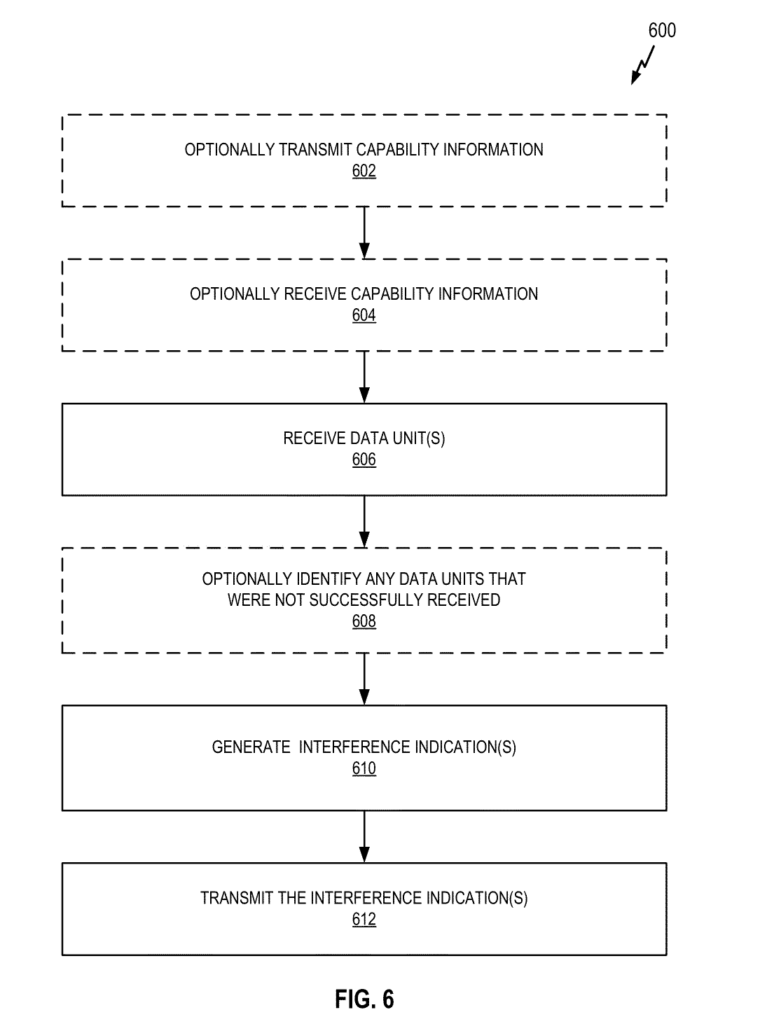

FIG. 6 illustrates a method 600 that includes additional operations for generating and transmitting an interference indication in accordance with some aspects of the disclosure. In some aspects, the method 600 may be performed by a first apparatus that receives data units from a second apparatus and, as applicable, transmits an interference indication back to the second apparatus. In some aspects, the method 600 may be performed by the apparatus 302 and/or the apparatus 304 illustrated in FIG. 3. In other aspects, the method 600 may be performed by a processing system 1904 (FIG. 19). Of course, in various aspects within the scope of the disclosure, the method 600 may be implemented by any suitable apparatus capable of supporting interference-related operations.

As represented by optional blocks 602 and 604, in some implementations the first apparatus conducts a capability exchange with the second apparatus. The apparatuses may conduct such a capability exchange, for example, in cases where the apparatuses employ non-standardized signaling (e.g., using reserved bits, reusing bits, etc.). In this case, the apparatuses may agree whether to use this signaling and, if so, how the signaling is to be used.

To this end, as represented by optional block 602, the first apparatus may transmit capability information to the second apparatus. In some aspects, this capability information may indicate that the first apparatus supports sending indications of whether data units are subjected to interference.

In some implementations, the capability information indicates where the indications are to be located in messages sent from the first apparatus to the second apparatus. For example, the capability information may indicate the frame(s) to be used, the field(s) to be used, and the bit(s) to be used.

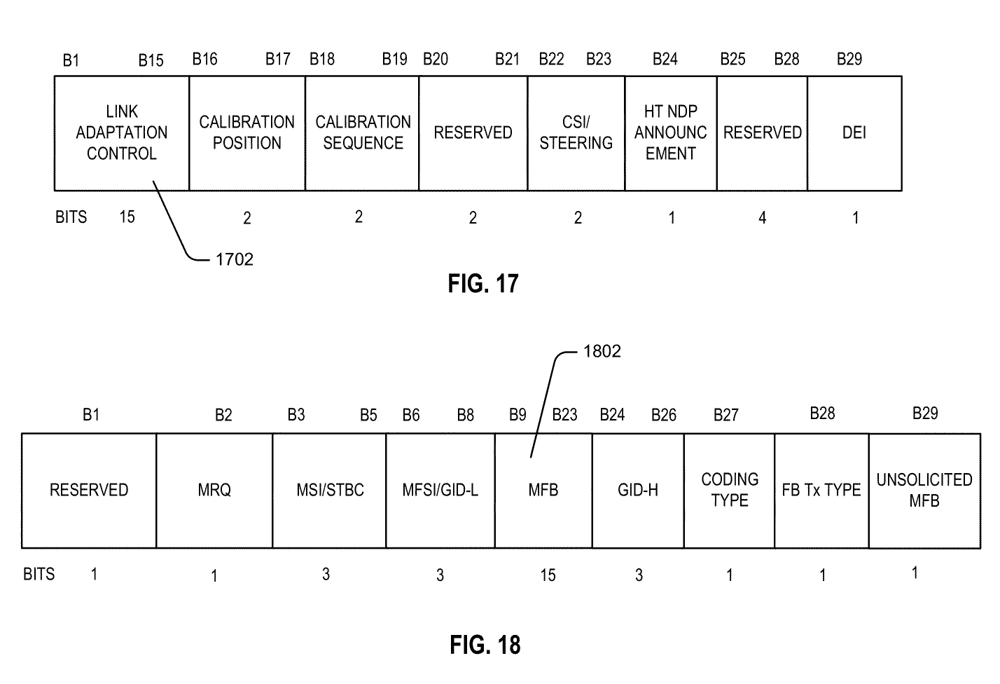

In some implementations, the capability information indicates that the indications are to be substituted for other information that would otherwise be sent in messages from the first apparatus to the second apparatus. For example, the capability information may indicate that MCS information bit remapping as discussed in FIGS. 17 and 18 is to be used to send the interference indications.

As represented by optional block 604, the first apparatus may receive capability information from the second apparatus. In some aspects, this capability information may indicate that the second apparatus supports receiving indications of whether data units are subjected to interference. In some implementations, the capability information received at block 604 indicates where the indications are expected to be located in messages sent from the first apparatus to the second apparatus (e.g., in a similar manner as discussed above at block 602). In some implementations, the capability information received at block 604 indicates that the indications are expected to be substituted for other information that would otherwise be sent in messages from the first apparatus to the second apparatus (e.g., in a similar manner as discussed above at block 602).

The operations of blocks 602 and 604 are optional in the sense that such a capability exchange mechanism may not be needed in some cases. For example, if interference indication feedback is standardized for a wireless system, the apparatuses that support that standard might not need to negotiate to use the feedback. Rather, the use of such feedback may be expected.

As represented by block 606, at some point in time, the first apparatus receives at least one data unit transmitted by the second apparatus. The operations of block 606 may correspond to the operations of block 402 discussed above.

As represented by optional block 608, in some cases, the first apparatus will identify any data units that were not successfully received. Unsuccessful reception may take various forms.

A data unit that is partially received may be deemed to be unsuccessfully received. For example, some of the symbols of the data unit might not be detected at a receiver due to fading or interference.

A data unit may be received with error. For example, a data unit may be associated with a corresponding error detection code that is based on the data unit. In the event error detection covering a received data unit indicates an error, the data unit may be deemed as having been unsuccessfully received.

As yet another example, a portion of a received packet (comprising one or more data units) may have been corrupted or lost during transmission. Thus, some or all of the data units in the packet may be deemed to be unsuccessfully received data units.

As represented by block 610, the first apparatus determines whether the at least one data unit received at block 606 was subjected to interference during the transmission of the data unit(s) from the second apparatus to the first apparatus. In conjunction with this determination, the first apparatus generates at least one indication that indicates whether the at least one data unit was subjected to interference. The operations of block 610 may correspond to the operations of block 404 discussed above.

As represented by block 612, the first apparatus transmits the at least one indication to the second apparatus. The operations of block 612 may correspond to the operations of block 406 discussed above.

In some implementations, the first apparatus transmits information based on the operations of block 608. For example, the at least one indication may indicate, for each of the data units that was not successfully received, whether the data unit was subjected to interference. Again, a bit map or some other suitable indicia may be employed to provide this information. For example, for a given data unit, a first indication can be provided to indicate where the data unit was successfully received and a second indication can be provided to indicate whether that data unit was subjected to interference. As another example, a single indication may indicate that a corresponding data block was not successfully received due to interference.

Furthermore, in some implementations, an indication as to whether a data block was not successfully received due to channel conditions may be generated and transmitted to the second apparatus. For example, a receiver can determine whether a deteriorated channel condition (e.g., a drop in SNR associated with received signals) coincides with unsuccessful data reception. If so, the receiver can generate an indication indicating as such. This indication may take the form of a bit map or some other suitable form as discussed above for interference indicia (e.g., a single indication for a packet, individual indications for individual data blocks, or some other form of indication).

Thus, in some cases, the first apparatus may transmit multiple bit fields to the second apparatus. One bit field can indicate whether a data block was successfully received. In addition, at least one other bit field can indicate the cause of the failure (e.g., interference and/or channel conditions).

Also as discussed above, in some implementations, an indication is indicative of time. For example, an indication may indicate when interference and/or poor channel conditions commenced. As another example, an indication may indicate how long interference and/or poor channel conditions lasted. Such timing information may relate to actual time (e.g., as kept by the apparatuses), relative time, or the transmission of data (e.g., a position in a sequence of bits, symbols, or packets, etc.).

Interference counts, poor channel condition counts, or corresponding indications may be aggregated in some implementations. Accordingly, an aggregate indication may be sent once the aggregation is completed. For example, an aggregate indication may be sent at specified times (e.g., periodically), after a specified amount of data is sent (e.g., every 100 packets), after a specified number of trigger events have occurred (e.g., after 20 instances of interference have been detected), and so on.

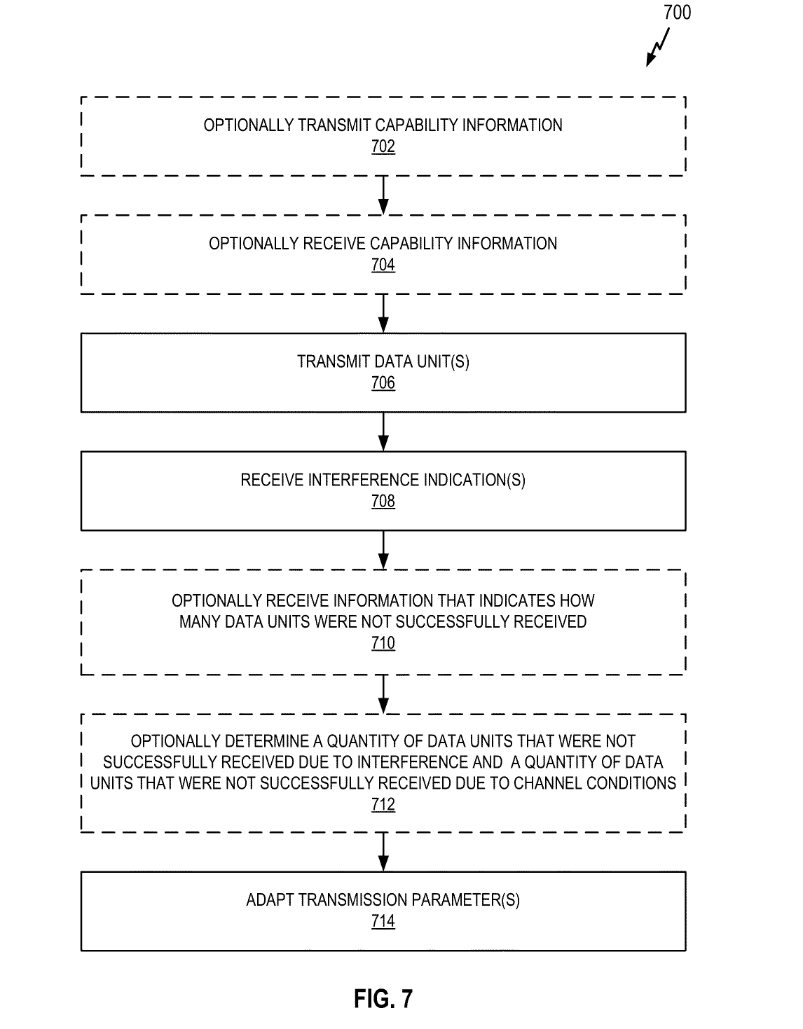

FIG. 7 illustrates a method 700 that includes additional operations for determining a transmission parameter based on a received interference indication in accordance with some aspects of the disclosure. In some aspects, the method 700 may be performed by the apparatus 302 and/or the apparatus 304 illustrated in FIG. 3. In other aspects, the method 700 may be performed by a processing system (e.g., the processing system 1904 of FIG. 19). Of course, in various aspects within the scope of the disclosure, the method 700 may be implemented by any suitable apparatus capable of supporting interference-related operations.

As in the method 500 of FIG. 5, the method 700 describes sample operations in the context of a first apparatus that receives an interference indication from a second apparatus. Thus, the nomenclature for the first apparatus and the second apparatus is reversed in FIG. 7 relative to the nomenclature used in FIG. 6.

As represented by optional blocks 702 and 704, in some implementations the first apparatus conducts a capability exchange with the second apparatus. The operations performed by the first apparatus here are thus complementary to the operations described above for blocks 602 and 604.

As represented by optional block 702, the first apparatus may transmit capability information to the second apparatus, where the capability information indicates that the first apparatus supports receiving indications of whether data units are subjected to interference. In addition, the capability information may indicate where the indications are to be located in messages to be sent from the second apparatus to the first apparatus. Also, the capability information may indicate that the indications are to be substituted for other information that would otherwise be sent in messages from the second apparatus to the first apparatus.

Similarly, as represented by optional block 704, the first apparatus may receive capability information transmitted by the second apparatus, where the capability information indicates that the second apparatus supports sending indications of whether data units are subjected to interference. The received capability information may indicate where the indications are to be located in messages to be sent from the second apparatus to the first apparatus. In addition, the received capability information may indicate that the indications are to be substituted for other information that would otherwise be sent in messages from the second apparatus to the first apparatus.

As represented by block 706, the first apparatus transmits at least one data unit to the second apparatus. The operations of block 706 may correspond to the operations of block 502 discussed above.

As represented by block 708, the first apparatus receives at least one indication transmitted by the second apparatus, where the at least one indication indicates whether the at least one data unit was subjected to interference during transmission. The operations of block 708 may correspond to the operations of block 504 discussed above.

As represented by optional block 710, in some cases, the first apparatus also receives information that indicates how many data units were not successfully received by the second apparatus. These operations are thus complementary to the operations of blocks 608 and 610 that describe optionally determining whether data units were successfully received and generating an indication accordingly.

As represented by optional block 712, in the event the information of block 710 is received by the first apparatus, the first apparatus may optionally determine how many of the data units were not successfully received due to interference and how many of the data units were not successfully received due to channel conditions (e.g., fading). As discussed herein, this information may be used by a transmitter to make a better decision regarding whether a transmission rate should be decreased in the face of high packet loss. In particular, if the unsuccessful receptions are due primarily to interference, a reduction in rate might not be called for.

As represented by block 714, the first apparatus determines at least one transmission parameter for transmission of at least one other data unit from the first apparatus to the second apparatus. In some aspects, this determination is based on the indication(s) received at block 708. The operations of block 714 may correspond to the operations of block 506 discussed above.

In some implementations, the determination of block 714 is based on the information received at block 710. For example, in a scenario where the first apparatus receives information that indicates how many data units were not successfully received by the second apparatus, the first apparatus can make a determination as to the severity of the failures and adjust the transmission parameter(s) accordingly (e.g., as discussed above).

Also in this scenario, the at least one indication received at block 808 may indicate, for each of the data units that was not successfully received, whether the data unit was subjected to interference. Consequently, the first apparatus can determine the extent of the receive failures due interference and adjust the transmission parameter(s) accordingly. For example, if only a small number of the receive failures were due to interference, the first apparatus may reduce the rate. Conversely, if a large number of the receive failures were due to interference, the first apparatus may take action to mitigate interference.

In some implementations, the determination of block 714 is based on the determination of block 712. For example, in cases where the first apparatus receives information that indicates how many data units were not successfully received by the second apparatus due to interference and how many data units were not successfully received by the second apparatus due to channel conditions, the first apparatus can make a determination as to the severity of any interference and adjust the transmission parameter(s) accordingly (e.g., as discussed above).

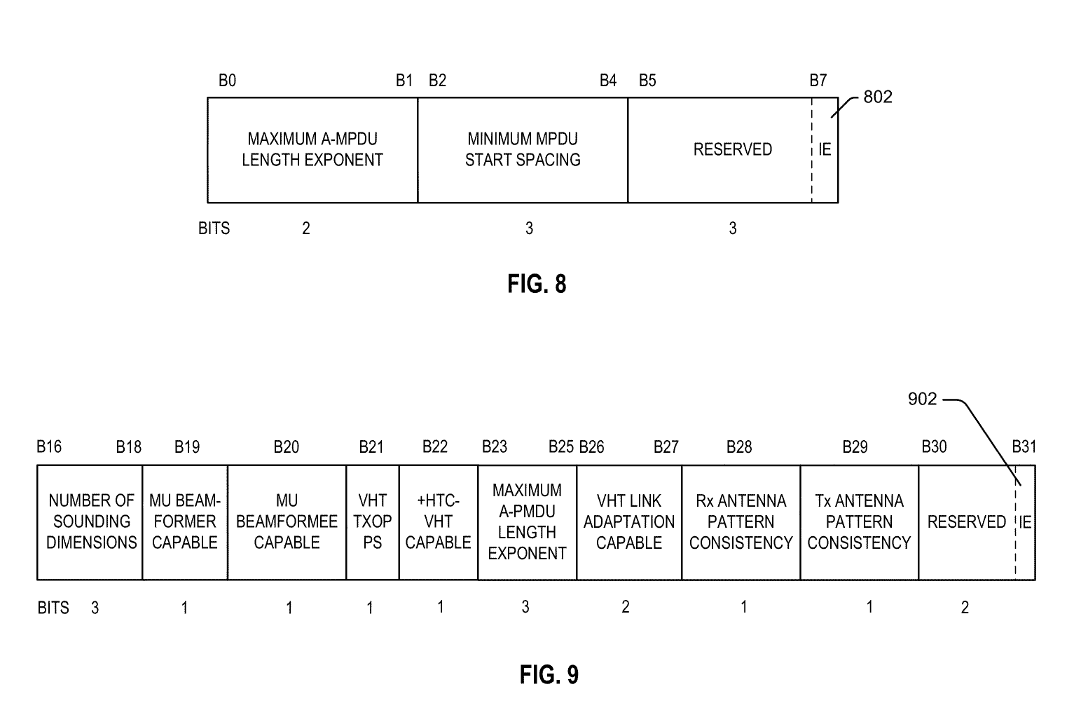

FIGS. 8-18 illustrate several examples of how information such as the interference indications, metrics, capability information, and other information discussed above may be conveyed in one or more existing frames. FIGS. 8-14 illustrate several examples of how capability information may be conveyed via existing IEEE 802.11-based frames. FIGS. 15-18 illustrates several examples of how an interference indication (e.g., metric) may be conveyed via existing IEEE 802.11-based frames.

Capability information may be carried in a new information element (IE) to be included in a Beacon or a Probe Request Response for STAs that support interference signaling as taught herein. Also, the capability information may be carried in an existing capability indication in high throughput (HT) or very high throughput (VHT) capabilities reserved bits. This information may be exchanged, for example, at association for a transmitter and a receiver.

As shown in FIG. 8, a capability information IE 802 may be carried in one or more of the reserved bits that are defined for an A-MPDU Parameters Field. For example, capability information may be carried in one or more of bits 5, 6, or 7.

As shown in FIG. 9, a capability information IE 902 may be carried in one or more of the reserved bits that are defined for a VHT Capabilities Info Field. For example, capability information may be carried in one or more of bits 30 or 31.

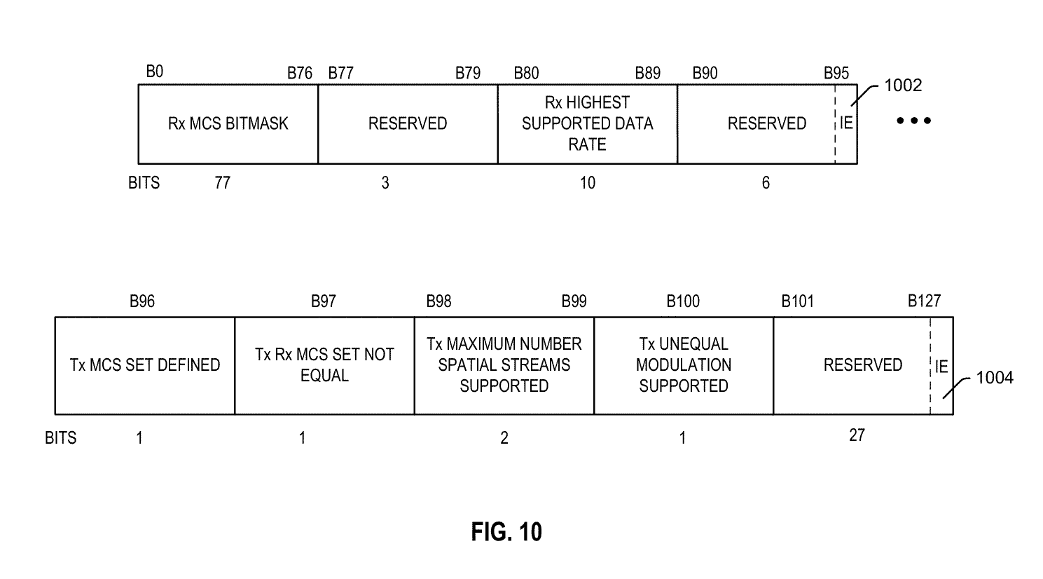

As shown in FIG. 10, a capability information IE 1002 and/or a capability information IE 1004 may be carried in one or more of the reserved bits that are defined for a Supported MCS Set Field. For example, capability information may be carried in one or more of bits 90-95 and/or one or more of bits 101-127.

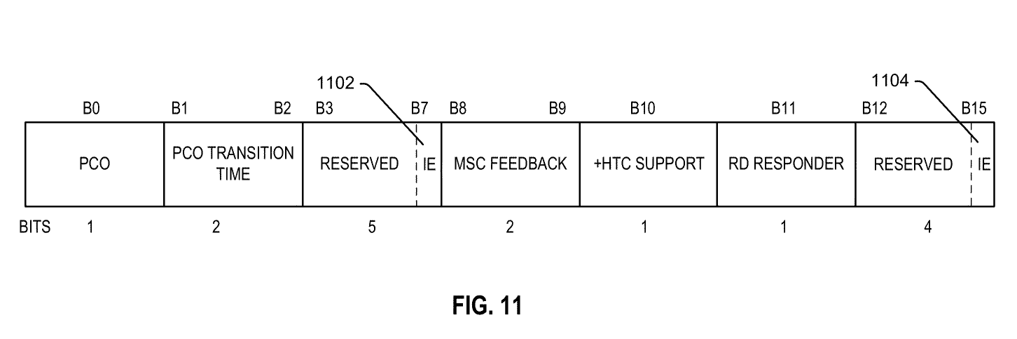

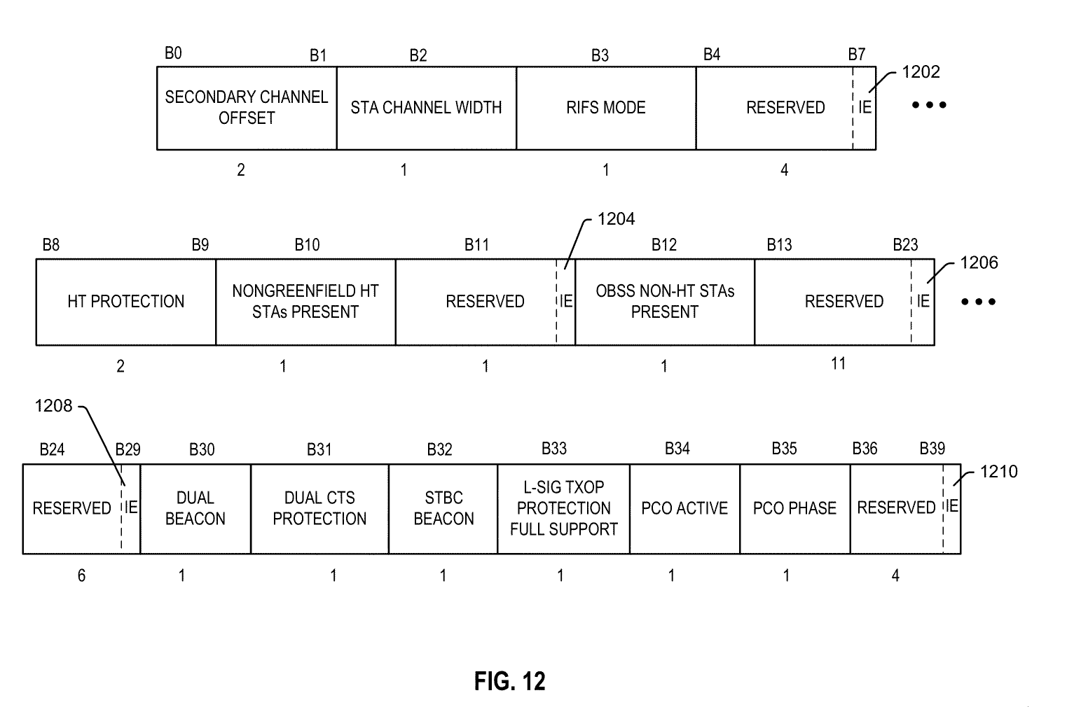

Referring to FIGS. 11 and 12, capability information may be carried in reserved bits in existing HT extended capabilities. Again, this information may be exchanged at association.

As shown in FIG. 11, a capability information IE 1102 and/or a capability information IE 1104 may be carried in one or more of the reserved bits that are defined for an HT Extended Capabilities Field. For example, capability information may be carried in one or more of bits 3-7 and/or one or more of bits 12-15.

As shown in FIG. 12, one or more capability information IEs 1202, 1204, 1206, 1208, or 1210 may be carried in one or more of the reserved bits that are defined for an HT Operation Information Field. For example, capability information may be carried in one or more of any of the following bits: bits 4-7, bit 11, bits 13-23, bits 24-29, or bits 36-39.

Capability information may be carried in reinterpreted fields in an Add Block ACK (ADDBA) frame (e.g., in a sequence control field). The sequence control field has same format as in Block ACK Request (BAR) as described in FIG. 14 below.

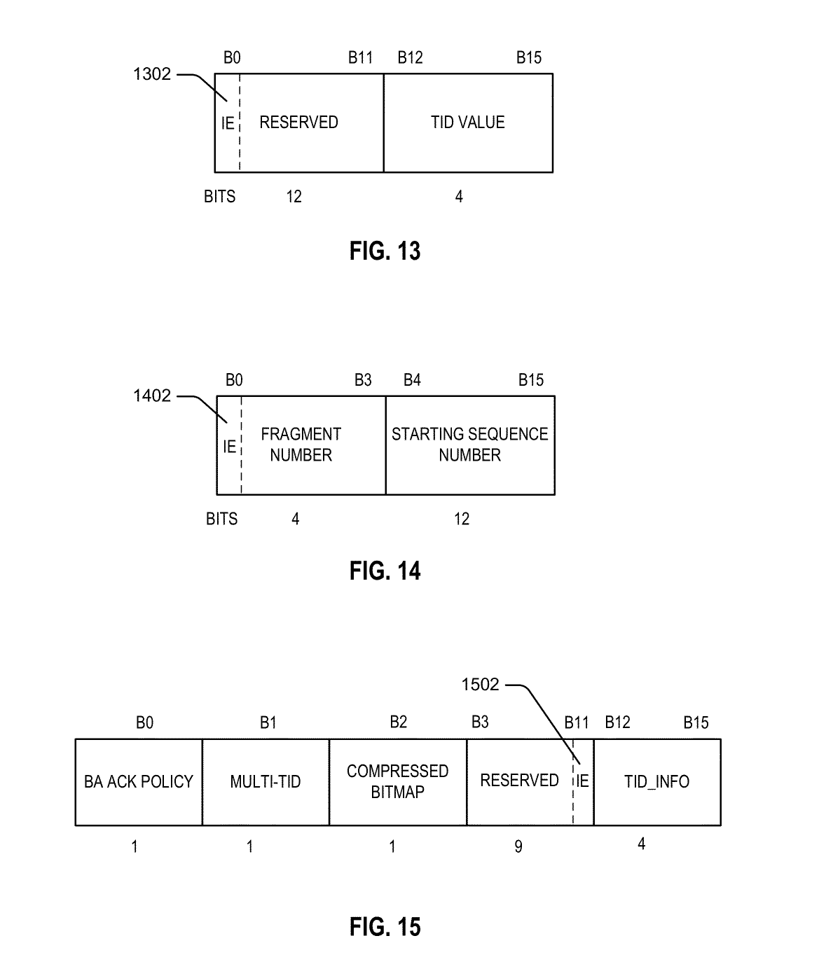

Capability information may be sent on demand, based on the Per-TID reserved field in multi-traffic identifier (multi-TID) BAR. For example, as shown in FIG. 13, a capability information IE 1302 may be carried in one or more of the reserved bits that are defined for a Per TID Info Subfield. For example, capability information may be carried in one or more of bits 0-11.

Capability information may be sent on demand, based on the Fragment Number of the Starting Sequence Control in a basic/compressed BAR. For example, as shown in FIG. 14, a capability information IE 1402 may be carried in one or more of the bits that are defined for a Block ACK Starting Sequence Control Field. Alternatively, the Fragment Number itself may indicate capability information. Thus, capability information may be carried in one or more of bits 0-3.

Referring now to FIGS. 15-18, several examples of messages that may carry an interference indication (e.g., metric signaling) are described.

An interference indication may be carried by a Block ACK (BA) frame as shown in FIG. 15. The BA frame includes a Control field that has reserved bits. For example, an interference indication IE 1502 may be carried in one or more of bits 3-11. In some implementations, these reserved bits are used to carry any interference indications (e.g., metrics) related to the packets(s) for which the BA is providing acknowledgment.

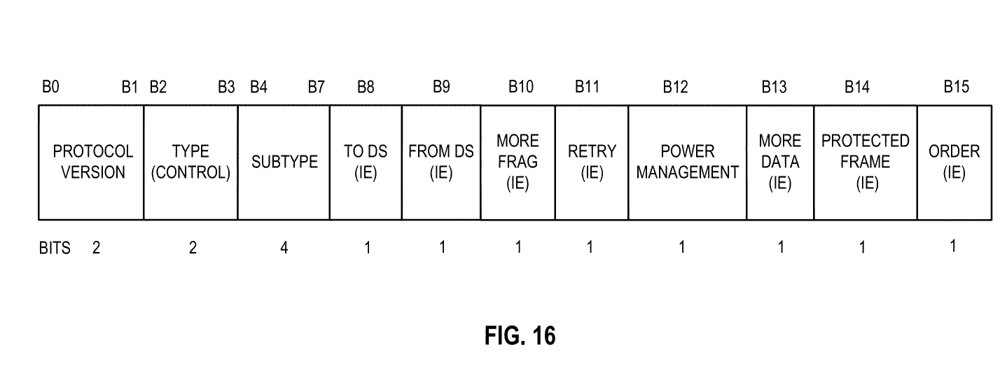

Referring to FIG. 16, control frames such as ACK and CTS have unused bits that may be used to carry an interference indication. For example, an interference indication IE (indicated as (IE)) may be carried in one or more of bits 8, 9, 10, 11, 13, 14, or 15 in the Frame Control field of FIG. 16. Again, one or more of these bits may be used to carry any interference indications (e.g., metrics) related to the packets(s) for which the BA is providing acknowledgment.

As another example, a new negative ACK (NACK) frame may be defined. In this way, a receiver may send an indication to a transmitter that a packet or some of the data units in the packet were not successfully received due to interference.

Similarly, interference-related signaling may be communicated using a new dedicated frame. For example, a new Action frame carrying interference indications (e.g., metrics) related to past transmissions may be averaged, may be accumulated, or may have listed values. In addition, this Action frame may include a reference to the time interval or MPDU sequence number interval to which the interference indications (e.g., metrics) refer.

Referring now to FIGS. 17 and 18, a mechanism for sending information also may be provided by reusing bits that were previously defined for other purposes. For example, bits used for 802.11 fast link adaptation may be reused in some cases.

The 802.11 Standard defines a mechanism for a sender station (STA) to send a frame with an HT control field (in HT or VHT variant) to request feedback and a receiver STA to send a frame with an HT control field (in HT or VHT variant). Information such as modulation and coding scheme (MCS), signal-to-noise ratio (SNR), and bandwidth (BW) may be sent via this feedback mechanism (e.g., see 8.2.4.6 HT Control field, Sec 9.28 in 802.11-2012 and related sections in 802.11ac).

This same mechanism can be used to feedback the desired interference indications (e.g., metrics) instead of the MCS, SNR, or BW, assuming the transmitter and receiver have the capability to reuse these bits and have agreed to do so. In this case, the receiver STA may encode some of the fields in the HT Control field (e.g., one or more of MCS, SNR, or BW) to indicate a preferred metric (e.g., an interference indication). Thus, this metric will be different from the one indicated by the Standard. This is a direct communication, and both the transmitter and the receiver agreed on the reinterpretation of the fields as mentioned above. In some implementations, the modified feedback can be enabled based on capabilities only. In some implementations, enabling of the modified feedback may also depend on a special indication included in the preceding HT control field including a request for feedback (e.g., some fields in and HT control field could be used for this purpose).

In FIG. 17, bits that normally carry MCS-related information are in the Link Adaptation Control section 1702 of the subfields. Hence, one or more of bits 1-15 could be reallocated to carry interference indications.

In FIG. 18, bits that normally carry MCS-related information are in the MCS Feedback (MFB) section 1802 of the subfields. Hence, one or more of bits 9-23 could be reallocated to carry interference indications.

In some implementations, a transmitter selects the rate to be used (e.g., based on packet loss feedback and interference feedback). In these cases, the MCS bits are not used for MCS feedback since the receiver is no longer specifying the MCS to be used. Consequently, these MCS bits are readily available to use for reallocation.

FIG. 19 illustrates various components that may be utilized in an apparatus 1902 (e.g., a wireless device) that may be employed within the wireless communication system 100. The apparatus 1902 is an example of a device that may be configured to implement the various methods described herein. For example, the apparatus 1902 may comprise the AP 104, a relay, one of the STAs 106 of FIG. 1 or FIG. 2, or some other type of apparatus.

The apparatus 1902 may include a processing system 1904 that controls operation of the apparatus 1902. The processing system 1904 may also be referred to as a central processing unit (CPU). A memory component 1906 (e.g., including a memory device), which may include both read-only memory (ROM) and random access memory (RAM), provides instructions and data to the processing system 1904. A portion of the memory component 1906 may also include non-volatile random access memory (NVRAM). The processing system 1904 typically performs logical and arithmetic operations based on program instructions stored within the memory component 1906. The instructions in the memory component 1906 may be executable to implement the methods described herein.

When the apparatus 1902 is implemented or used as a transmitting node, the processing system 1904 may be configured to select one of a plurality of media access control (MAC) header types, and to generate a packet having that MAC header type. For example, the processing system 1904 may be configured to generate a packet comprising a MAC header and a payload and to determine what type of MAC header to use.

When the apparatus 1902 is implemented or used as a receiving node, the processing system 1904 may be configured to process packets of a plurality of different MAC header types. For example, the processing system 1904 may be configured to determine the type of MAC header used in a packet and process the packet and/or fields of the MAC header.

The processing system 1904 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The apparatus 1902 may also include a housing 1908 that may include a transmitter 1910 and a receiver 1912 to allow transmission and reception of data between the apparatus 1902 and a remote location. The transmitter 1910 and receiver 1912 may be combined into single communication component (e.g., a transceiver 1914). An antenna 1916 may be attached to the housing 1908 and electrically coupled to the transceiver 1914. The apparatus 1902 may also include (not shown) multiple transmitters, multiple receivers, multiple transceivers, and/or multiple antennas. A transmitter 1910 and a receiver 1912 may comprise an integrated device (e.g., embodied as a transmitter circuit and a receiver circuit of a single communication device) in some implementations, may comprise a separate transmitter device and a separate receiver device in some implementations, or may be embodied in other ways in other implementations.

The transmitter 1910 may be configured to wirelessly transmit packets having different MAC header types. For example, the transmitter 1910 may be configured to transmit packets with different types of headers generated by the processing system 1904, discussed above.

The receiver 1912 may be configured to wirelessly receive packets having different MAC header types. In some aspects, the receiver 1912 is configured to detect a type of a MAC header used and process the packet accordingly.

The receiver 1912 may be used to detect and quantify the level of signals received by the transceiver 1914. The receiver 1912 may detect such signals as total energy, energy per subcarrier per symbol, power spectral density and other signals. The apparatus 1902 may also include a digital signal processor (DSP) 1920 for use in processing signals. The DSP 1920 may be configured to generate a data unit for transmission. In some aspects, the data unit may comprise a physical layer data unit (PPDU). In some aspects, the PPDU is referred to as a packet.

The apparatus 1902 may further comprise a user interface 1922 in some aspects. The user interface 1922 may comprise a keypad, a microphone, a speaker, and/or a display. The user interface 1922 may include any element or component that conveys information to a user of the apparatus 1902 and/or receives input from the user.

The various components of the apparatus 1902 may be coupled together by a bus system 1926. The bus system 1926 may include a data bus, for example, as well as a power bus, a control signal bus, and a status signal bus in addition to the data bus. Those of skill in the art will appreciate the components of the apparatus 1902 may be coupled together or accept or provide inputs to each other using some other mechanism.

Although a number of separate components are illustrated in FIG. 19, one or more of the components may be combined or commonly implemented. For example, the processing system 1904 may be used to implement not only the functionality described above with respect to the processing system 1904, but also to implement the functionality described above with respect to the signal detector 1918 and/or the DSP 1920. Further, each of the components illustrated in FIG. 19 may be implemented using a plurality of separate elements. Furthermore, the processing system 1904 may be used to implement any of the components, modules, circuits, or the like described below, or each may be implemented using a plurality of separate elements.

For ease of reference, when the apparatus 1902 is configured as a transmitting node, it is hereinafter referred to as an apparatus 1902t. Similarly, when the apparatus 1902 is configured as a receiving node, it is hereinafter referred to as an apparatus 1902r. A device in the wireless communication system 100 may implement only functionality of a transmitting node, only functionality of a receiving node, or functionality of both a transmitting node and a receive node.

As discussed above, the apparatus 1902 may comprise an AP, a relay, a STA, or some other type of apparatus. In addition, the apparatus 1902 may be used to transmit and/or receive communication having a plurality of MAC header types.

The components of FIG. 19 may be implemented in various ways. In some implementations, the components of FIG. 19 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks of FIG. 19 may be implemented by processor and memory component(s) of the apparatus (e.g., by execution of appropriate code and/or by appropriate configuration of processor components). It should be appreciated that these components may be implemented in different types of apparatuses in different implementations (e.g., in an ASIC, in a system-on-a-chip (SoC), etc.).

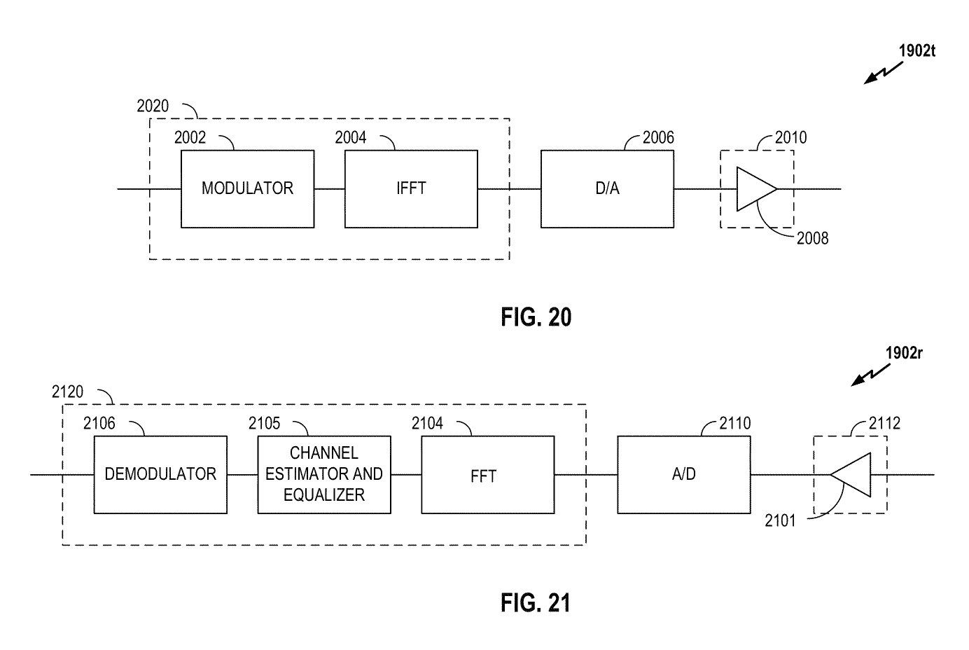

As discussed above, the apparatus 1902 may comprise an AP, a relay, a STA, or some other type of apparatus, and may be used to transmit and/or receive communication. FIG. 20 illustrates various components that may be utilized in the apparatus 1902t to transmit wireless communication. The components illustrated in FIG. 20 may be used, for example, to transmit OFDM communication. In some aspects, the components illustrated in FIG. 20 are used to generate and transmit packets to be sent over a bandwidth of less than or equal to 1 MHz.

The apparatus 1902t of FIG. 20 may comprise a modulator 2002 configured to modulate bits for transmission. For example, the modulator 2002 may determine a plurality of symbols from bits received from the processing system 1904 (FIG. 19) or the user interface 1922 (FIG. 19), for example by mapping bits to a plurality of symbols according to a constellation. The bits may correspond to user data or to control information. In some aspects, the bits are received in codewords. In one aspect, the modulator 2002 comprises a QAM (quadrature amplitude modulation) modulator, for example a 16-QAM modulator or a 64-QAM modulator. In other aspects, the modulator 2002 comprises a binary phase-shift keying (BPSK) modulator or a quadrature phase-shift keying (QPSK) modulator.

The apparatus 1902t may further comprise a transform module 2004 configured to convert symbols or otherwise modulated bits from the modulator 2002 into a time domain. In FIG. 20, the transform module 2004 is illustrated as being implemented by an inverse fast Fourier transform (IFFT) module. In some implementations, there may be multiple transform modules (not shown) that transform units of data of different sizes. In some implementations, the transform module 2004 may be itself configured to transform units of data of different sizes. For example, the transform module 2004 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 64 points are used to convert symbols being transmitted over 64 tones into a time domain. The number of points used by the transform module 2004 may be referred to as the size of the transform module 2004.

In FIG. 20, the modulator 2002 and the transform module 2004 are illustrated as being implemented in the DSP 2020. In some aspects, however, one or both of the modulator 2002 and the transform module 2004 are implemented in the processing system 1904 or in another element of the apparatus 1902t (e.g., see description above with reference to FIG. 19).

As discussed above, the DSP 2020 may be configured to generate a data unit for transmission. In some aspects, the modulator 2002 and the transform module 2004 may be configured to generate a data unit comprising a plurality of fields including control information and a plurality of data symbols.

Returning to the description of FIG. 20, the apparatus 1902t may further comprise a digital to analog converter 2006 configured to convert the output of the transform module into an analog signal. For example, the time-domain output of the transform module 2006 may be converted to a baseband OFDM signal by the digital to analog converter 2006. The digital to analog converter 2006 may be implemented in the processing system 1904 or in another element of the apparatus 1902 of FIG. 19. In some aspects, the digital to analog converter 2006 is implemented in the transceiver 1914 (FIG. 19) or in a data transmit processor.

The analog signal may be wirelessly transmitted by the transmitter 2010. The analog signal may be further processed before being transmitted by the transmitter 2010, for example by being filtered or by being upconverted to an intermediate or carrier frequency. In the aspect illustrated in FIG. 20, the transmitter 2010 includes a transmit amplifier 2008. Prior to being transmitted, the analog signal may be amplified by the transmit amplifier 2008. In some aspects, the amplifier 2008 comprises a low noise amplifier (LNA).

The transmitter 2010 is configured to transmit one or more packets or data units in a wireless signal based on the analog signal. The data units may be generated using the processing system 1904 (FIG. 19) and/or the DSP 2020, for example using the modulator 2002 and the transform module 2004 as discussed above. Data units that may be generated and transmitted as discussed above are described in additional detail below.

FIG. 21 illustrates various components that may be utilized in the apparatus 1902 of FIG. 19 to receive wireless communication. The components illustrated in FIG. 21 may be used, for example, to receive OFDM communication. For example, the components illustrated in FIG. 21 may be used to receive data units transmitted by the components discussed above with respect to FIG. 20.

The receiver 2112 of apparatus 1902r is configured to receive one or more packets or data units in a wireless signal. Data units that may be received and decoded or otherwise processed as discussed below.

In the aspect illustrated in FIG. 21, the receiver 2112 includes a receive amplifier 2101. The receive amplifier 2101 may be configured to amplify the wireless signal received by the receiver 2112. In some aspects, the receiver 2112 is configured to adjust the gain of the receive amplifier 2101 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 2101 comprises an LNA.

The apparatus 1902r may comprise an analog to digital converter 2110 configured to convert the amplified wireless signal from the receiver 2112 into a digital representation thereof. Further to being amplified, the wireless signal may be processed before being converted by the digital to analog converter 2110, for example by being filtered or by being downconverted to an intermediate or baseband frequency. The analog to digital converter 2110 may be implemented in the processing system 1904 (FIG. 19) or in another element of the apparatus 1902r. In some aspects, the analog to digital converter 2110 is implemented in the transceiver 1914 (FIG. 19) or in a data receive processor.

The apparatus 1902r may further comprise a transform module 2104 configured to convert the representation of the wireless signal into a frequency spectrum. In FIG. 21, the transform module 2104 is illustrated as being implemented by a fast Fourier transform (FFT) module. In some aspects, the transform module may identify a symbol for each point that it uses. As described above with reference to FIG. 20, the transform module 2104 may be configured with a plurality of modes, and may use a different number of points to convert the signal in each mode. The number of points used by the transform module 2104 may be referred to as the size of the transform module 2104. In some aspects, the transform module 2104 may identify a symbol for each point that it uses.

The apparatus 1902r may further comprise a channel estimator and equalizer 2105 configured to form an estimate of the channel over which the data unit is received, and to remove certain effects of the channel based on the channel estimate. For example, the channel estimator 2105 may be configured to approximate a function of the channel, and the channel equalizer may be configured to apply an inverse of that function to the data in the frequency spectrum.

The apparatus 1902r may further comprise a demodulator 2106 configured to demodulate the equalized data. For example, the demodulator 2106 may determine a plurality of bits from symbols output by the transform module 2104 and the channel estimator and equalizer 2105, for example by reversing a mapping of bits to a symbol in a constellation. The bits may be processed or evaluated by the processing system 1904 (FIG. 19), or used to display or otherwise output information to the user interface 1922 (FIG. 19). In this way, data and/or information may be decoded. In some aspects, the bits correspond to codewords. In one aspect, the demodulator 2106 comprises a QAM (quadrature amplitude modulation) demodulator, for example a 16-QAM demodulator or a 64-QAM demodulator. In other aspects, the demodulator 2106 comprises a binary phase-shift keying (BPSK) demodulator or a quadrature phase-shift keying (QPSK) demodulator.

In FIG. 21, the transform module 2104, the channel estimator and equalizer 2105, and the demodulator 2106 are illustrated as being implemented in the DSP 2120. In some aspects, however, one or more of the transform module 2104, the channel estimator and equalizer 2105, and the demodulator 2106 are implemented in the processing system 1904 (FIG. 19) or in another element of the apparatus 1902 (FIG. 19).

As discussed above, the wireless signal received at the receiver 1912 comprises one or more data units. Using the functions or components described above, the data units or data symbols therein may be decoded evaluated or otherwise evaluated or processed. For example, the processing system 1904 (FIG. 19) and/or the DSP 2120 may be used to decode data symbols in the data units using the transform module 2104, the channel estimator and equalizer 2105, and the demodulator 2106.

Data units exchanged by the AP 104 and the STA 106 may include control information or data, as discussed above. At the physical (PHY) layer, these data units may be referred to as physical layer protocol data units (PPDUs). In some aspects, a PPDU may be referred to as a packet or physical layer packet. Each PPDU may comprise a preamble and a payload. The preamble may include training fields and a SIG field. The payload may comprise a Media Access Control (MAC) header or data for other layers, and/or user data, for example. The payload may be transmitted using one or more data symbols. The systems, methods, and devices herein may utilize data units with training fields whose peak-to-power ratio has been minimized.

The apparatus 1902t shown in FIG. 20 shows an example of a single transmit chain to be transmitted over an antenna. The apparatus 1902r shown in FIG. 21 shows an example of a single receive chain to be received over an antenna. In some implementations, the apparatus 1902t or 1902r may implement a portion of a MIMO system using multiple antennas to simultaneously transmit data.

The wireless network 100 may employ methods to allow efficient access of the wireless medium based on unpredictable data transmissions while avoiding collisions. As such, in accordance with various aspects, the wireless network 100 performs carrier sense multiple access/collision avoidance (CSMA/CA) that may be referred to as the Distributed Coordination Function (DCF). More generally, an apparatus 1902 having data for transmission senses the wireless medium to determine if the channel is already occupied. If the apparatus 1902 senses the channel is idle then the apparatus 1902 transmits prepared data. Otherwise, the apparatus 1902 may defer for some period before determining again whether or not the wireless medium is free for transmission. A method for performing CSMA may employ various gaps between consecutive transmissions to avoid collisions. In an aspect, transmissions may be referred to as frames and a gap between frames is referred to as an Interframe Spacing (IFS). Frames may be any one of user data, control frames, management frames, and the like.

IFS time durations may vary depending on the type of time gap provided. Some examples of IFS include a Short Interframe Spacing (SIFS), a Point Interframe Spacing (PIFS), and a DCF Interframe Spacing (DIFS) where SIFS is shorter than PIFS, which is shorter than DIFS. Transmissions following a shorter time duration will have a higher priority than one which must wait longer before attempting to access the channel.

A wireless apparatus may include various components that perform functions based on signals that are transmitted by or received at the wireless apparatus. For example, in some implementations a wireless apparatus comprises a user interface configured to output an indication based on a received signal as taught herein.

A wireless apparatus as taught herein may communicate via one or more wireless communication links that are based on or otherwise support any suitable wireless communication technology. For example, in some aspects a wireless apparatus may associate with a network such as a local area network (e.g., a Wi-Fi network) or a wide area network. To this end, a wireless apparatus may support or otherwise use one or more of a variety of wireless communication technologies, protocols, or standards such as, for example, Wi-Fi, WiMAX, CDMA, TDMA, OFDM, and OFDMA. Also, a wireless apparatus may support or otherwise use one or more of a variety of corresponding modulation or multiplexing schemes. A wireless apparatus may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

The teachings herein may be incorporated into (e.g., implemented within or performed by) a variety of apparatuses (e.g., nodes). In some aspects, a wireless apparatus (e.g., a wireless node or a wireless device) implemented in accordance with the teachings herein may comprise an access point, a relay, or an access terminal.

An access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

A relay may comprise, be implemented as, or known as a relay node, a relay device, a relay station, a relay apparatus, or some other similar terminology. As discussed above, in some aspects, a relay may comprise some access terminal functionality and some access point functionality.

In some aspects, a wireless apparatus comprises an access device (e.g., an access point) for a communication system. Such an access device provides, for example, connectivity to another network (e.g., a wide area network such as the Internet or a cellular network) via a wired or wireless communication link. Accordingly, the access device enables another device (e.g., a wireless station) to access the other network or some other functionality. In addition, it should be appreciated that one or both of the devices may be portable or, in some cases, relatively non-portable. Also, it should be appreciated that a wireless apparatus also may be capable of transmitting and/or receiving information in a non-wireless manner (e.g., via a wired connection) via an appropriate communication interface.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1xRTT, 1xEV-DO Re10, RevA, RevB) technology and other technologies.

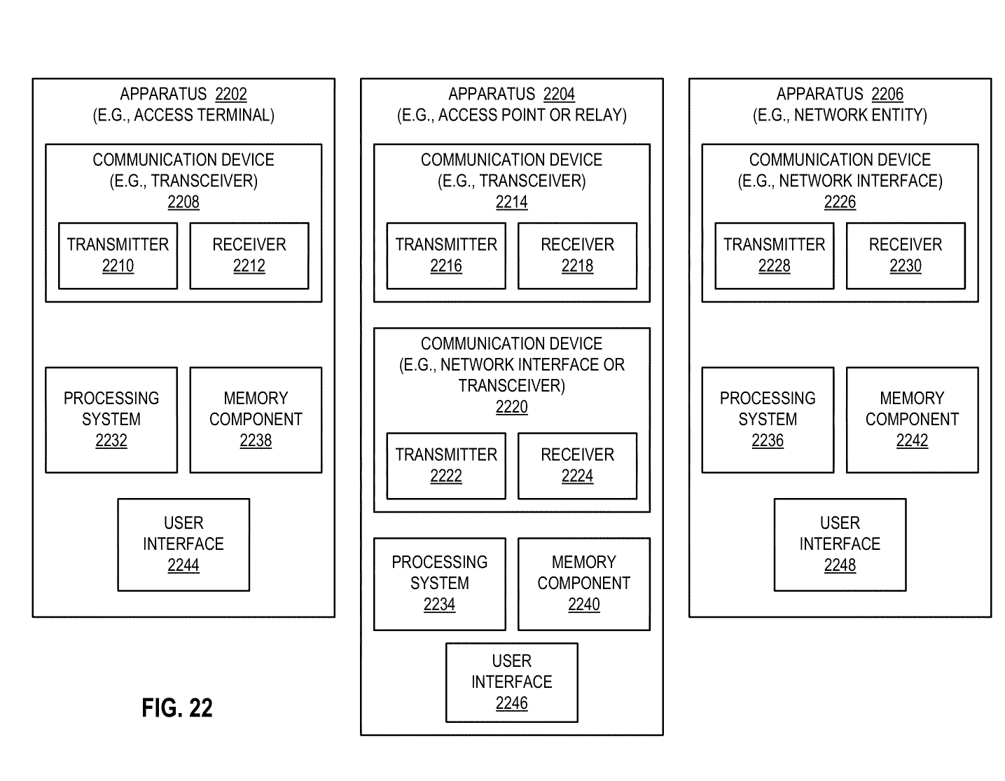

FIG. 22 illustrates several sample components (represented by corresponding blocks) that may be incorporated into an apparatus 2202, an apparatus 2204, and an apparatus 2206 (e.g., corresponding to an access terminal, an access point or relay, and a network entity (e.g., network device), respectively) to perform communication operations as taught herein. It should be appreciated that these components may be implemented in different types of apparatuses in different implementations (e.g., in an ASIC, in a system on a chip (SoC), etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 2202 and the apparatus 2204 each include at least one wireless communication device (represented by the communication devices 2208 and 2214 (and the communication device 2220 if the apparatus 2204 is a relay)) for communicating with other nodes via at least one designated radio access technology. Each communication device 2208 includes at least one transmitter (represented by the transmitter 2210) for transmitting and encoding signals (e.g., messages, indications, information, and so on) and at least one receiver (represented by the receiver 2212) for receiving and decoding signals (e.g., messages, indications, information, pilots, and so on). Similarly, each communication device 2214 includes at least one transmitter (represented by the transmitter 2216) for transmitting signals (e.g., messages, indications, information, pilots, and so on) and at least one receiver (represented by the receiver 2218) for receiving signals (e.g., messages, indications, information, and so on). If the apparatus 2204 is a relay, each communication device 2220 includes at least one transmitter (represented by the transmitter 2222) for transmitting signals (e.g., messages, indications, information, pilots, and so on) and at least one receiver (represented by the receiver 2224) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 2204 comprises a network listen module.

The apparatus 2206 (and the apparatus 2204 if it is an access point) includes at least one communication device (represented by the communication device 2226 and, optionally, 2220) for communicating with other nodes. For example, the communication device 2226 may comprise a network interface that is configured to communicate with one or more network entities via a wire-based or wireless backhaul. In some aspects, the communication device 2226 may be implemented as a transceiver configured to support wire-based or wireless signal communication. This communication may involve, for example, sending and receiving: messages, parameters, or other types of information. Accordingly, in the example of FIG. 22, the communication device 2226 is shown as comprising a transmitter 2228 and a receiver 2230. Similarly, if the apparatus 2204 is an access point, the communication device 2220 may comprise a network interface that is configured to communicate with one or more network entities via a wire-based or wireless backhaul. As with the communication device 2226, the communication device 2220 is shown as comprising a transmitter 2222 and a receiver 2224.

The apparatuses 2202, 2204, and 2206 also include other components that may be used in conjunction with communication operations as taught herein. The apparatus 2202 includes a processing system 2232 for providing functionality relating to, for example, communicating with the apparatus 2204 (or some other apparatus) as taught herein and for providing other processing functionality. The apparatus 2204 includes a processing system 2234 for providing functionality relating to, for example, communicating with the apparatus 2202 (or some other apparatus) as taught herein and for providing other processing functionality. The apparatus 2206 includes a processing system 2236 for providing functionality relating to, for example, supporting communication by the apparatuses 2202 and 2204 (or some other apparatuses) as taught herein and for providing other processing functionality. The apparatuses 2202, 2204, and 2206 include memory devices 2238, 2240, and 2242 (e.g., each including a memory device), respectively, for maintaining information (e.g., parameters, and so on). In addition, the apparatuses 2202, 2204, and 2206 include user interface devices 2244, 2246, and 2248, respectively, for providing indications (e.g., audible and/or visual indications) to a user and/or for receiving user input (e.g., upon user actuation of a sensing device such a keypad, a touch screen, a microphone, and so on).

For convenience, the apparatus 2202 is shown in FIG. 22 as including components that may be used in the various examples described herein. In practice, the illustrated blocks may have different functionality in different aspects. For example, functionality of the block 2234 for supporting the operations of FIG. 4 may be different as compared to functionality of the block 2234 for supporting the operations of FIG. 6.

The components of FIG. 22 may be implemented in various ways. In some implementations, the components of FIG. 22 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 2208, 2232, 2238, and 2244 may be implemented by processor and memory component(s) of the apparatus 2202 (e.g., by execution of appropriate code and/or by appropriate configuration of processor components). Similarly, some or all of the functionality represented by blocks 2214, 2220, 2234, 2240, and 2246 may be implemented by processor and memory component(s) of the apparatus 2204 (e.g., by execution of appropriate code and/or by appropriate configuration of processor components). Also, some or all of the functionality represented by blocks 2226, 2236, 2242, and 2248 may be implemented by processor and memory component(s) of the apparatus 2206 (e.g., by execution of appropriate code and/or by appropriate configuration of processor components).

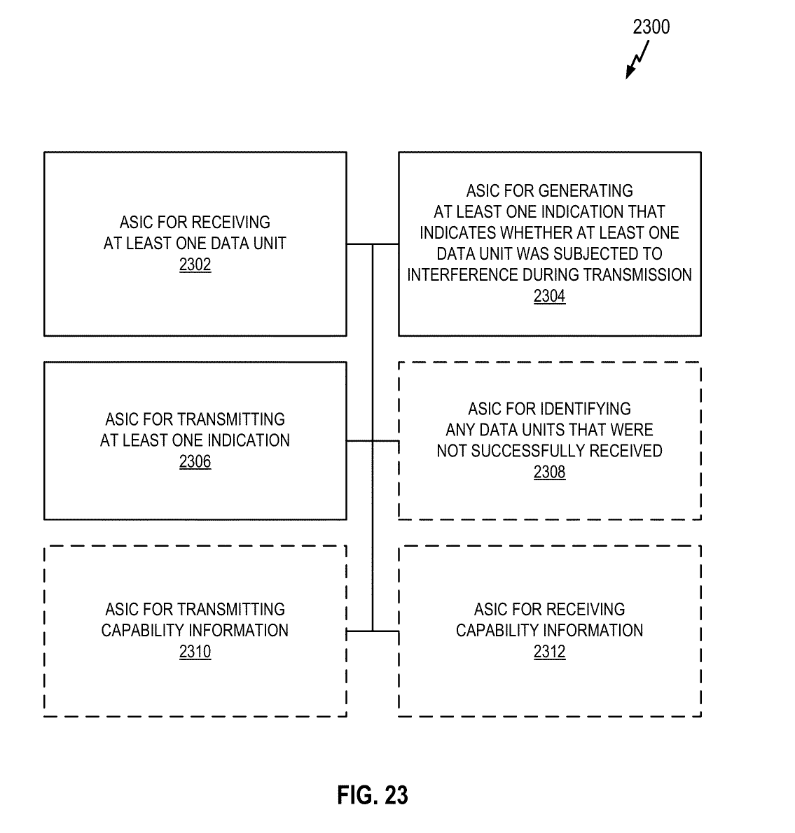

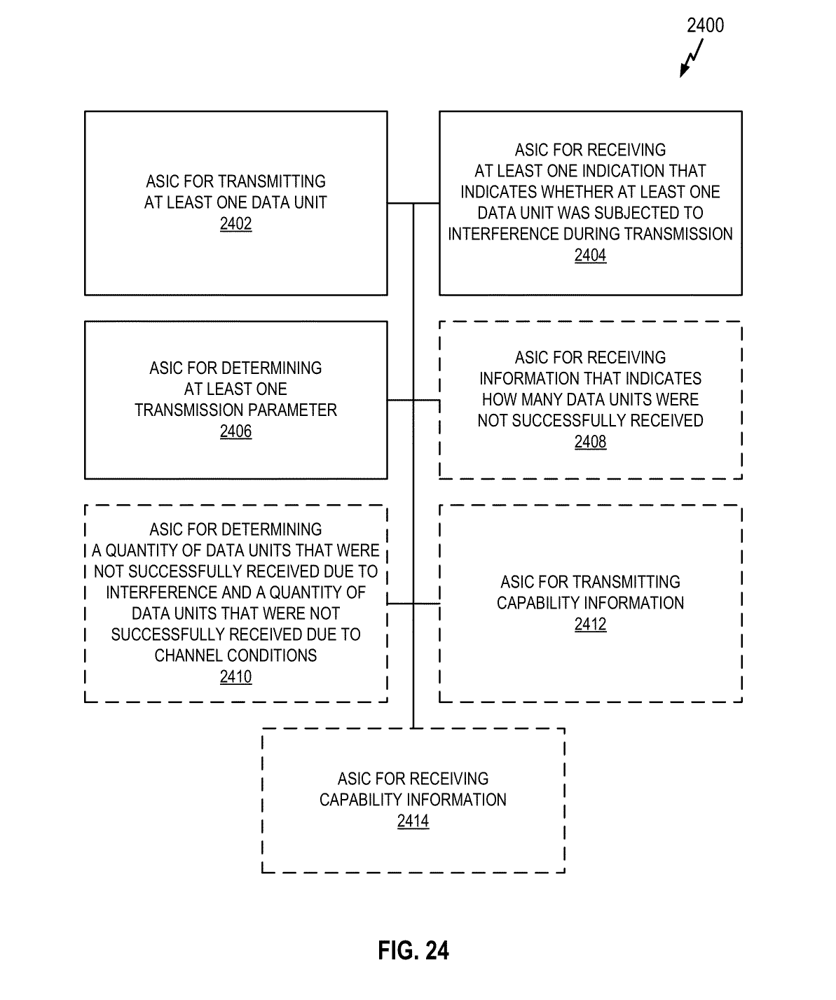

The components described herein may be implemented in a variety of ways. Referring to FIGS. 23 and 24, apparatuses 2300 and 2400 are represented as a series of interrelated functional blocks that represent functions implemented by, for example, one or more integrated circuits (e.g., an ASIC) or implemented in some other manner as taught herein. As discussed herein, an integrated circuit may include a processor, software, other components, or some combination thereof.

The apparatus 2300 includes one or more modules that may perform one or more of the functions described above with regard to various figures. For example, an ASIC for receiving at least one data unit 2302 may correspond to, for example, a receiver (e.g., comprising an RF receive chain circuit) as discussed herein. An ASIC for generating at least one indication that indicates whether at least one data unit was subjected to interference during transmission 2304 may correspond to, for example, a processing system as discussed herein. An ASIC for transmitting at least one indication 2306 may correspond to, for example, a transmitter as discussed herein. An ASIC for identifying any data units that were not successfully received 2308 may correspond to, for example, a processing system as discussed herein. An ASIC for transmitting capability information 2310 may correspond to, for example, a transmitter as discussed herein. An ASIC for receiving capability information 2312 may correspond to, for example, a receiver as discussed herein.

The apparatus 2400 also includes one or more modules that may perform one or more of the functions described above with regard to various figures. For example, an ASIC for transmitting at least one data unit 2402 may correspond to, for example, a transmitter as discussed herein. An ASIC for receiving at least one indication that indicates whether at least one data unit was subjected to interference during transmission 2404 may correspond to, for example, a processing system as discussed herein. An ASIC for determining at least one transmission parameter 2406 may correspond to, for example, a processing system as discussed herein. An ASIC for receiving information that indicates how many data units were not successfully received 2408 may correspond to, for example, a receiver as discussed herein. An ASIC for determining a quantity of data units that were not successfully received due to interference and a quantity of data units that were not successfully received due to channel conditions 2410 may correspond to, for example, a processing system as discussed herein. An ASIC for transmitting capability information 2412 may correspond to, for example, a transmitter as discussed herein. An ASIC for receiving capability information 2414 may correspond to, for example, a receiver as discussed herein.

As noted above, in some aspects these modules may be implemented via appropriate processor components. These processor components may in some aspects be implemented, at least in part, using structure as taught herein. In some aspects, a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects one or more of any components represented by dashed boxes are optional.

As noted above, the apparatuses 2300 and 2400 comprise one or more integrated circuits in some implementations. For example, in some aspects a single integrated circuit implements the functionality of one or more of the illustrated components, while in other aspects more than one integrated circuit implements the functionality of one or more of the illustrated components. As one specific example, the apparatus 2300 may comprise a single device (e.g., with components 2302-2312 comprising different sections of an ASIC). As another specific example, the apparatus 2300 may comprise several devices (e.g., with the components 2302, 2306, 2310, and 2312 comprising one ASIC and the components 2304 and 2308 comprising another ASIC).

In addition, the components and functions represented by FIGS. 23 and 24 as well as other components and functions described herein, may be implemented using any suitable means. Such means are implemented, at least in part, using corresponding structure as taught herein. For example, the components described above in conjunction with the “ASIC for” components of FIGS. 23 and 24 correspond to similarly designated “means for” functionality. Thus, one or more of such means is implemented using one or more of processor components, integrated circuits, or other suitable structure as taught herein in some implementations. Several examples follow. In some aspects, means for receiving comprises a receiver. In some aspects, means for detecting comprises a processing system. In some aspects, means for generating comprises a processing system. In some aspects, means for transmitting comprises a transmitter. In some aspects, means for identifying comprises a processing system. In some aspects, means for determining comprises a processing system.

In some implementations, communication device structure such as a transceiver is configured to embody the functionality of a means for receiving. For example, this structure may be programmed or designed to invoke a receive operation. In addition, this structure may be programmed or designed to process (e.g., demodulate and decode) any signals received as a result of the receive operation. In addition, this structure may be programmed or designed to output data (e.g., a data unit, capability information, an indication, or other information) extracted from the received signals as a result of the processing. Typically, the communication device structure comprises a wireless-based transceiver device or wire-based transceiver device.

In some implementations, communication device structure such as a transceiver is configured to embody the functionality of a means for transmitting. For example, this structure may be programmed or designed to obtain data (e.g., a data unit, capability information, an indication, or other information) to be transmitted. In addition, this structure may be programmed or designed to process (e.g., modulate and encode) the obtained data. In addition, this structure may be programmed or designed to couple the processed data to one or more antennas for transmission. Typically, the communication device structure comprises a wireless-based transceiver device or wire-based transceiver device.

In some implementations, processing system structure such as an ASIC or a programmable processor is configured to embody the functionality of a means for generating at least one indication that indicates whether at least one data unit was subjected to interference during transmission. This structure may be programmed or designed to obtain a received data unit. This structure may be programmed or designed to process the received data to determine whether the data unit was subjected to interference. For example, this may involve invoking one or more of the algorithms described above in conjunction with FIG. 4. The structure may be programmed or designed to then output an indication indicative of the results of the processing. In some implementations, the structure is configured to implement the interference indication-related functionality described in conjunction with one or more of FIG. 3, 4, or 6.

In some implementations, processing system structure such as an ASIC or a programmable processor is configured to embody the functionality of a means for identifying any of the data units that were not successfully received. This structure may be programmed or designed to obtain received signaling information. This structure may be programmed or designed to process the received signaling information to determine whether the signaling information, as transmitted, would have included one or more data units. In addition, this structure may the process the received signaling information to determine whether any of the one or more data units were not successfully received. For example, this may involve invoking the operations described above in conjunction with FIG. 4. The structure may be programmed or designed to then output an indication indicative of the results of the processing. In some implementations, the structure is configured to implement the interference indication-related functionality described in conjunction with one or more of FIG. 3, 4, or 6.

In some implementations, processing system structure such as an ASIC or a programmable processor is configured to embody the functionality of a means for determining at least one transmission parameter. This structure may be programmed or designed to obtain an indication as to whether at least one data unit was subjected to interference during the transmission. This structure may be programmed or designed to determine (e.g., adapt) a transmission parameter depending on the value of the indication. For example, this may involve selecting a transmission parameter as described above in conjunction with FIG. 5. The structure may be programmed or designed to then output the final transmission parameter value. In some implementations, the structure is configured to implement the interference indication-related functionality described in conjunction with one or more of FIG. 3, 5, or 7.

In some implementations, processing system structure such as an ASIC or a programmable processor is configured to embody the functionality of a means for determining a quantity of data units that were not successfully received due to interference and a quantity of data units that were not successfully received due to channel conditions. This structure may be programmed or designed to obtain received data units. This structure may be programmed or designed to process the received data units to determine whether any of the data units were not successfully received. In addition, this structure may be programmed or designed to determine whether any of the data units were not successfully received due to interference. Also, this structure may be programmed or designed to determine whether any of the data units were not successfully received due to channel conditions. This structure also may be programmed or designed to quantify the number data units that were not successfully received due to interference and to quantify the data units that were not successfully received due to channel conditions. This structure may be programmed or designed to output an indication indicative of the results of the quantification. In some implementations, the structure is configured to implement the interference indication-related functionality described in conjunction with one or more of FIG. 3, 5, or 7.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Also, it should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

Those of skill in the art understand that information and signals may be represented using any of a variety of different technologies and techniques. For example, any data, instructions, commands, information, signals, bits, symbols, and chips referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code executable (e.g., executable by at least one computer) to provide functionality relating to one or more of the aspects of the disclosure. In some aspects, a computer program product may comprise packaging materials.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product. Although particular aspects are described herein, many variations and permutations of these aspects fall within the scope of the disclosure.

Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the description.

The previous description of the disclosed aspects is provided to enable any person skilled in the art to make or use the disclosure. Various modifications to these aspects will be readily apparent to those skilled in the art, and the generic principles defined herein may be applied to other aspects without departing from the scope of the disclosure. Thus, the disclosure is not intended to be limited to the aspects shown herein but is to be accorded the widest scope consistent with the principles and novel features disclosed herein.

What is claimed is:

1. An apparatus configured for wireless communication, comprising:
a receiver configured to receive at least one data unit transmitted by a second apparatus;
a processing system configured to generate at least one indication that indicates whether the at least one data unit was subjected to interference during the transmission of the at least one data unit; and
a transmitter configured to transmit the at least one indication to the second apparatus.

2. The apparatus of claim 1, wherein:
the reception of the at least one data unit comprises receiving a plurality of data units; and
the at least one indication identifies each of the data units that was subjected to interference.

3. The apparatus of claim 1, wherein:
the reception of the at least one data unit comprises receiving a plurality of data units; and
the generation of the at least one indication comprises accumulating information regarding how many of the data units were subjected to interference and generating a metric based on the accumulated information.

4. The apparatus of claim 1, wherein:
the reception of the at least one data unit comprises receiving a plurality of data units;
the processing system is further configured to identify any of the data units that were not successfully received by the apparatus; and
the at least one indication indicates, for each of the data units that was not successfully received, whether the data unit was subjected to interference.

5. The apparatus of claim 1, wherein:
the at least one data unit comprises a plurality of symbols; and
the at least one indication indicates at least one of the symbols that was subjected to interference.

6. The apparatus of claim 1, wherein:
the at least one data unit comprises a plurality of symbols; and
the at least one indication identifies a quantity of the symbols that were subjected to interference.

7. The apparatus of claim 1, wherein:
the transmitter is further configured to transmit capability information to the second apparatus; and
the capability information indicates that the apparatus supports sending indications of whether data units are subjected to interference.

8. The apparatus of claim 7, wherein the capability information further indicates where the indications are to be located in messages sent from the apparatus to the second apparatus.

9. The apparatus of claim 7, wherein the capability information further indicates that the indications are to be substituted for other information that would otherwise be sent in messages from the apparatus to the second apparatus.

10. A method of wireless communication, comprising:
receiving, at a first apparatus, at least one data unit transmitted by a second apparatus;
generating at least one indication that indicates whether the at least one data unit was subjected to interference during the transmission of the at least one data unit; and
transmitting the at least one indication from the first apparatus to the second apparatus.

11. The method of claim 10, wherein:
the reception of the at least one data unit comprises receiving a plurality of data units; and
the at least one indication identifies each of the data units that was subjected to interference.

12. The method of claim 10, wherein:
the reception of the at least one data unit comprises receiving a plurality of data units; and
the generation of the at least one indication comprises accumulating information regarding how many of the data units were subjected to interference and generating a metric based on the accumulated information.

13. The method of claim 10, wherein:
the reception of the at least one data unit comprises receiving a plurality of data units;
the method further comprises identifying any of the data units that were not successfully received by the first apparatus; and
the at least one indication indicates, for each of the data units that was not successfully received, whether the data unit was subjected to interference.

14. The method of claim 10, wherein:
the at least one data unit comprises a plurality of symbols; and
the at least one indication indicates at least one of the symbols that was subjected to interference.

15. The method of claim 10, wherein:
the at least one data unit comprises a plurality of symbols; and
the at least one indication identifies a quantity of the symbols that were subjected to interference.

16. An apparatus configured for wireless communication, comprising:
a transmitter configured to transmit at least one data unit to a second apparatus;
a receiver configured to receive at least one indication transmitted by the second apparatus, wherein the at least one indication indicates whether the at least one data unit was subjected to interference during the transmission of the at least one data unit; and
a processing system configured to determine, based on the at least one indication, at least one transmission parameter for transmission of at least one other data unit from the apparatus to the second apparatus.

17. The apparatus of claim 16, wherein:
the at least one data unit comprises a plurality of data units; and
the at least one indication identifies each of the data units that was subjected to interference.

18. The apparatus of claim 16, wherein:
the at least one data unit comprises a plurality of data units; and
the at least one indication comprises accumulated information indicative of how many of the data units were subjected to interference.

19. The apparatus of claim 16, wherein:
the at least one data unit comprises a plurality of data units;
the data units are contained within a packet; and
the at least one indication indicates that one or more of the data units of the packet were subjected to interference.

20. The apparatus of claim 16, wherein:
the at least one data unit comprises a plurality of data units; and
the at least one indication indicates, for each of the data units that was not successfully received by the second apparatus, whether the data unit was subjected to interference.

21. The apparatus of claim 16, wherein:
the at least one data unit comprises a plurality of data units;
the receiver is further configured to receive information that indicates how many of the data units were not successfully received by the second apparatus;
the processing system is further configured to determine, based on the at least one indication and the received information, a first quantity of the data units that were not successfully received due to interference and a second quantity of the data units that were not successfully received due to channel conditions; and
the determination of the at least one transmission parameter is based on the first quantity and the second quantity.

22. The apparatus of claim 16, wherein:
the at least one data unit comprises a plurality of symbols; and
the at least one indication identifies at least one of the symbols that was subjected to interference.

23. The apparatus of claim 16, wherein:
the at least one data unit comprises a plurality of symbols; and
the at least one indication identifies a quantity of the symbols that were subjected to interference.

24. The apparatus of claim 16, wherein the determination of the at least one transmission parameter comprises determining whether to adapt a modulation and coding scheme.

25. A method of wireless communication, comprising:
transmitting at least one data unit from a first apparatus to a second apparatus;
receiving, at the first apparatus, at least one indication transmitted by the second apparatus, wherein the at least one indication indicates whether the at least one data unit was subjected to interference during the transmission of the at least one data unit; and
determining, based on the at least one indication, at least one transmission parameter for transmission of at least one other data unit from the first apparatus to the second apparatus.

26. The method of claim 25, wherein:
the at least one data unit comprises a plurality of data units; and
the at least one indication identifies each of the data units that was subjected to interference.

27. The method of claim 25, wherein:
the at least one data unit comprises a plurality of data units; and
the at least one indication comprises accumulated information indicative of how many of the data units were subjected to interference.

28. The method of claim 25, wherein:
the at least one data unit comprises a plurality of data units;
the data units are contained within a packet; and
the at least one indication indicates that one or more of the data units of the packet were subjected to interference.

29. The method of claim 25, wherein:
the at least one data unit comprises a plurality of data units; and
the at least one indication indicates, for each of the data units that was not successfully received by the second apparatus, whether the data unit was subjected to interference.

30. The method of claim 25, wherein:
the at least one data unit comprises a plurality of data units;
the method further comprises receiving information that indicates how many of the data units were not successfully received by the second apparatus;
the method further comprises determining, based on the at least one indication and the received information, a first quantity of the data units that were not successfully received due to interference and a second quantity of the data units that were not successfully received due to channel conditions; and
the determination of the at least one transmission parameter is based on the first quantity and the second quantity.
